(19) United States
(12) Patent Application Publication
(10) Pub. No.: US 2007/0063548 A1
(43) Pub. Date: Mar. 22, 2007

(54) Supporting frame structure

(76) Inventor: Konrad Eipper, Berlin (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/572,401

(22) PCT Filed: Aug. 17, 2004
(86) PCT No.: PCT/EP04/09211

§ 371 Date: Aug. 8, 2006

(30) Foreign Application Priority Data
Aug. 19, 2003 (EP) 03090256.3
Jun. 29, 2004 (EP) 04090263.7

(51) Int. Cl. B60K 37/00

(52) U.S. Cl. 296/203.01

(57) ABSTRACT

A supporting frame structure for a motor vehicle is provided with member-type elements and with junction elements connecting the member-type elements, at least one of the junction elements being designed as a cast-steel element, and at least one of the member-type elements is designed as a rolled steel profile.

The invention relates to a method for automatic online detection and classification of anomalous objects in a data stream according to claim 1 and an system to that aim according to claim 22.

In practical applications data analysis it is often necessary to evaluate the content of datasets so that the contents belong to certain classes.

One example would be the classification of measurements into normal and anomalous classes. The mathematical boundary between “normal” and “anomalous” is usually a mathematical condition which is either satisfied or not satisfied. From previous art (e.g. U.S. Pat. Nos. 5,640,492, 5,649,492, 6,327,581, as well as the following journal articles:

Cortes, C. and Vapnik, V. “Support Vector Networks”. Machine Learning, 1995, 20:273-297

K.-R. Müller and S. Mika and G. Rätsch and K. Tsuda and B. Schölkopf: “An Introduction to Kernel-Based Learning Algorithms”, IEEE Transactions on Neural Networks, 2001, 12:181-201)

it is known how to create an adaptable classification boundary as a result of an offline (batch) training process. It is also possible to apply adaptable classification repeatedly to batches of training data obtained from continuous data streams (e.g. US patent application 20030078683).

From previous art (e.g. the articles: P. A. Porras, and P. G. Neumann, “Emerald: event monitoring enabling responses to anomalous live disturbances”, Proc. National Information Systems Security Conference, 1997, pp. 353-365, and C. Warrender, S. Forrest and B. Perlmutter, “Detecting intrusions using system calls: alternative data methods”, Proc. IEEE Symposium on Security and Privacy, 1999, pp. 133-145) it is known how to detect outliers online, i.e. one example at a time, when the notion of normality is fixed in advance as a model.

It is not known, however, how to detect outliers in the continuous stream of data and at the same time to construct and the representation of normality and to dynamically adjust the representation with the arrival of new data or the removal of previous data. This form of data processing constitutes the scope of the invention.

The problem in real time application is that offline analysis is often not feasible or desirable.

One example for such an application would be the detection of an attack by a hacker to a computer system through a computer network.

The “normal” characteristics are known but it cannot in beforehand be defined how an attack would be represented in a datastream.

It is only be known in advance that a certain deviation from the normal situation will take places.

The current invention related to such situation in which datasets are analysed in real time without definite knowledge of the classification criteria to be used in the analysis.

In the following the invention is described by the way of example by

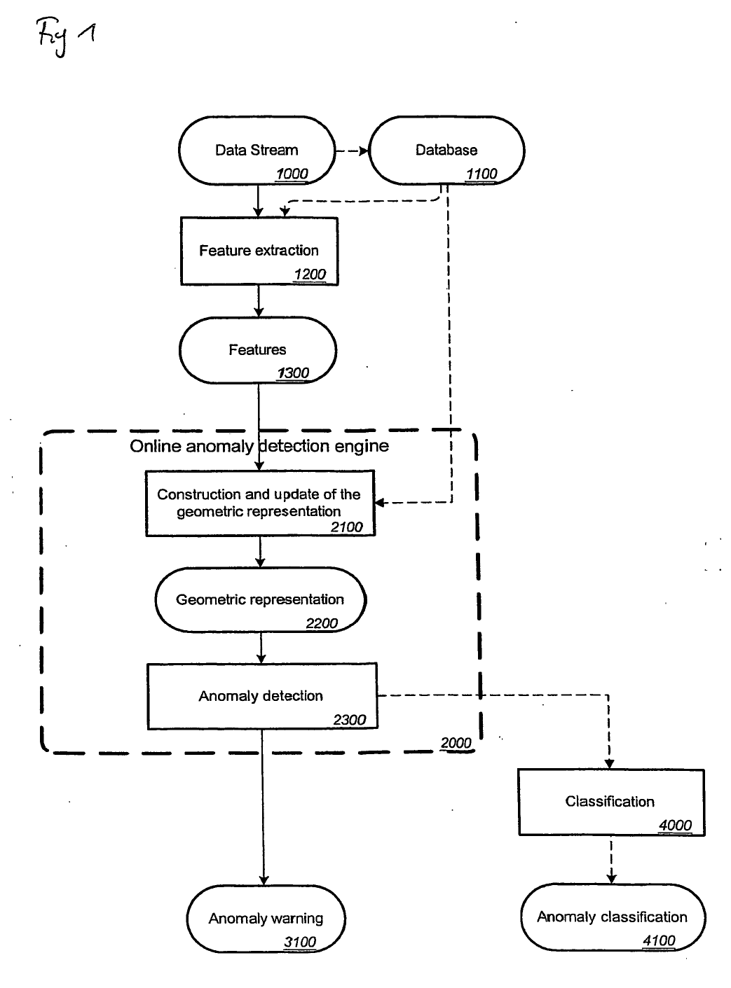

FIG. 1 depciting a flow-diagram of one embodiment of the invention;

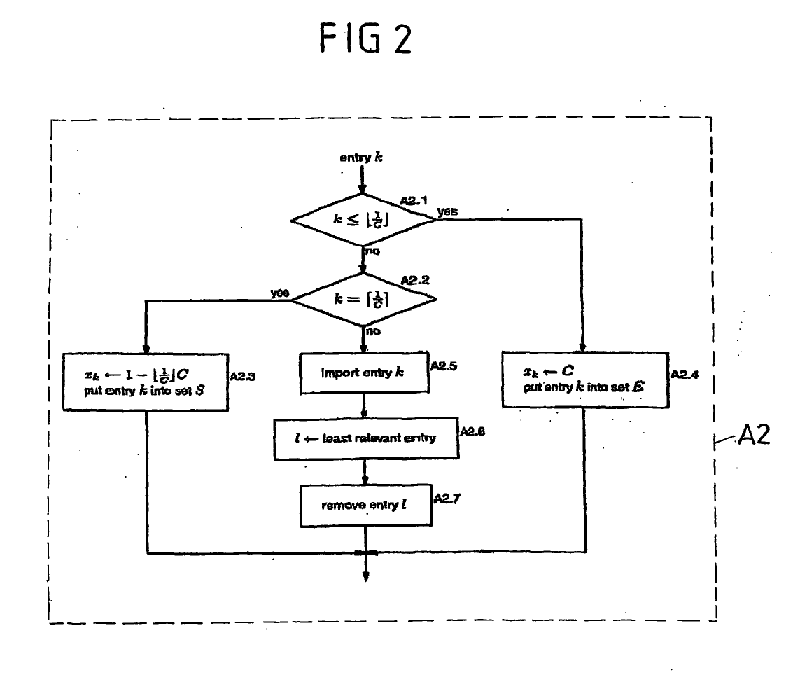

FIG. 2 depicting a detailed flow-diagram for the construction and updated of the geometric representation of normality;

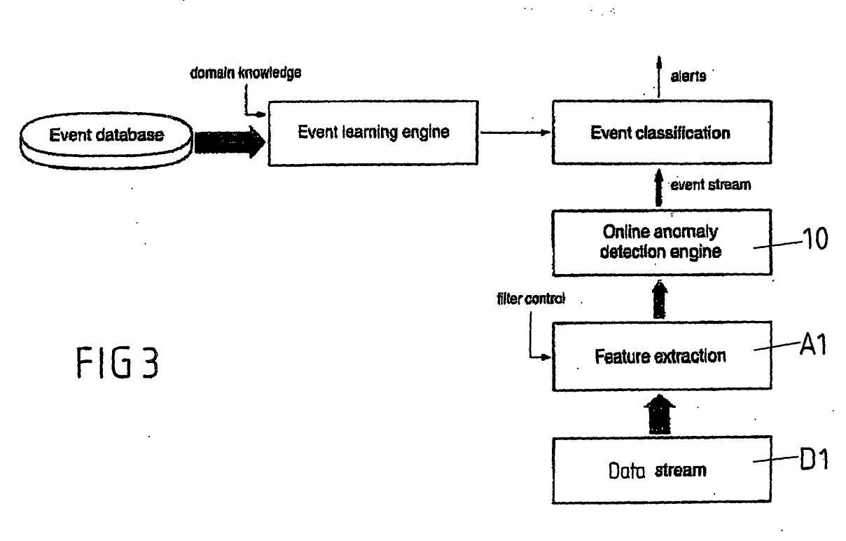

FIG. 3 depicting a schematic view of an embodiment of the inventive system for the detection of anomalous objects in connection with a computer network;

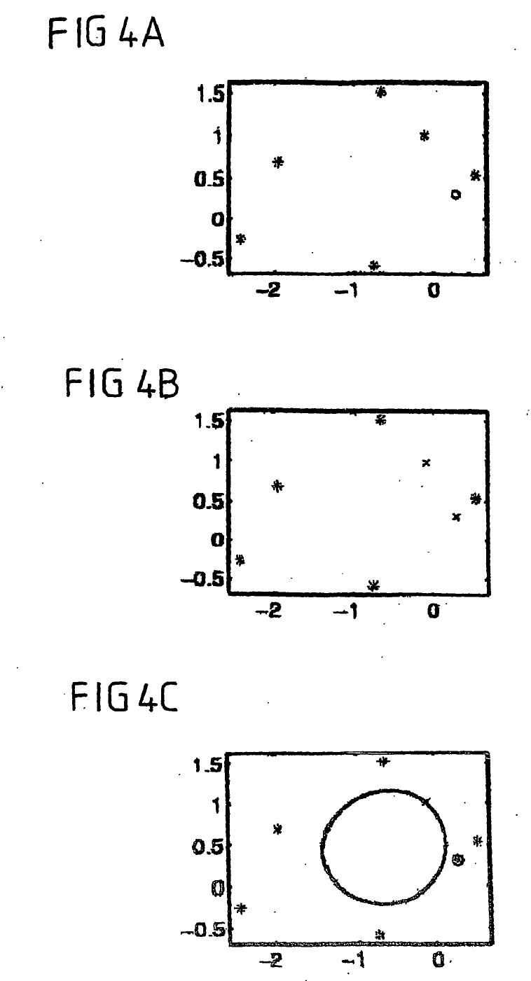

FIG. 4A-4C depicting examples for the initialisation of an embodiment of the invention;

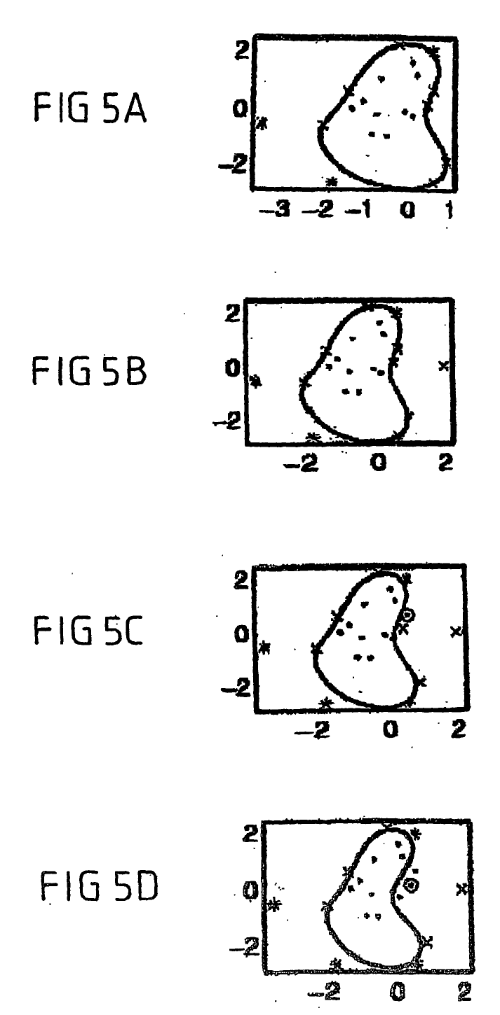

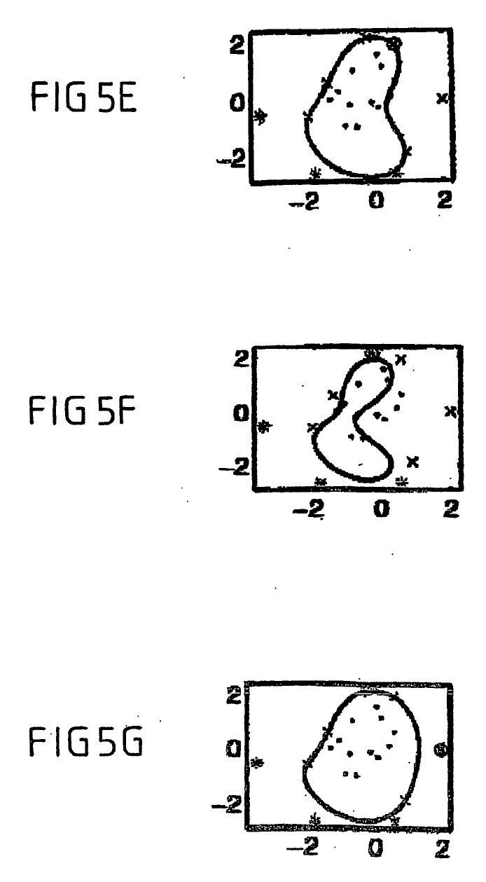

FIG. 5A-5G depicting examples for the further processing of an embodiment of the invention.

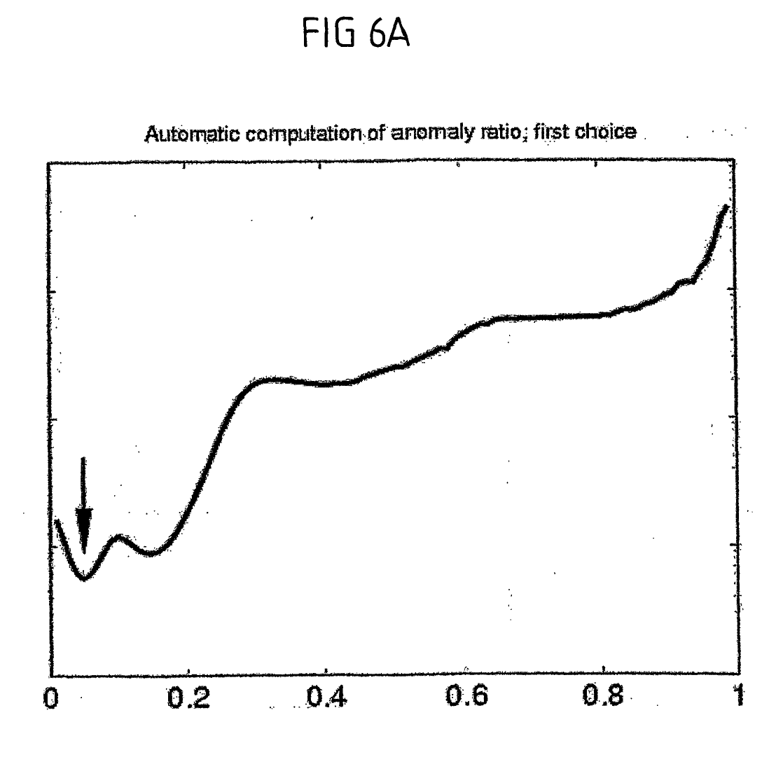

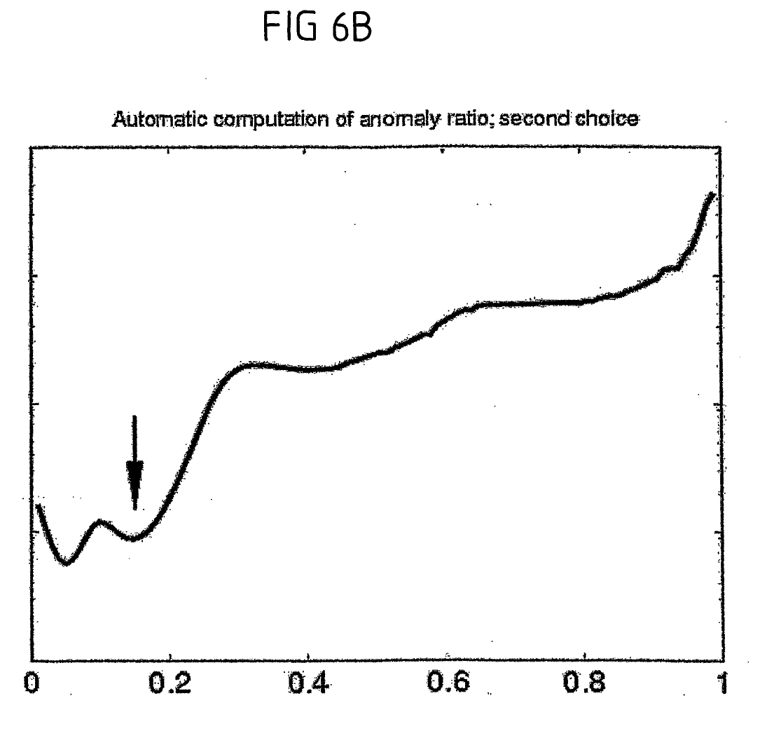

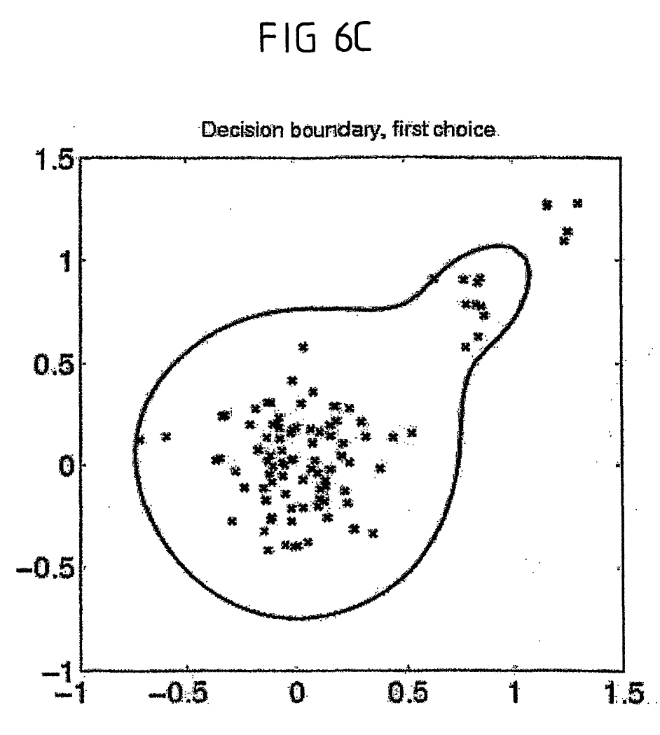

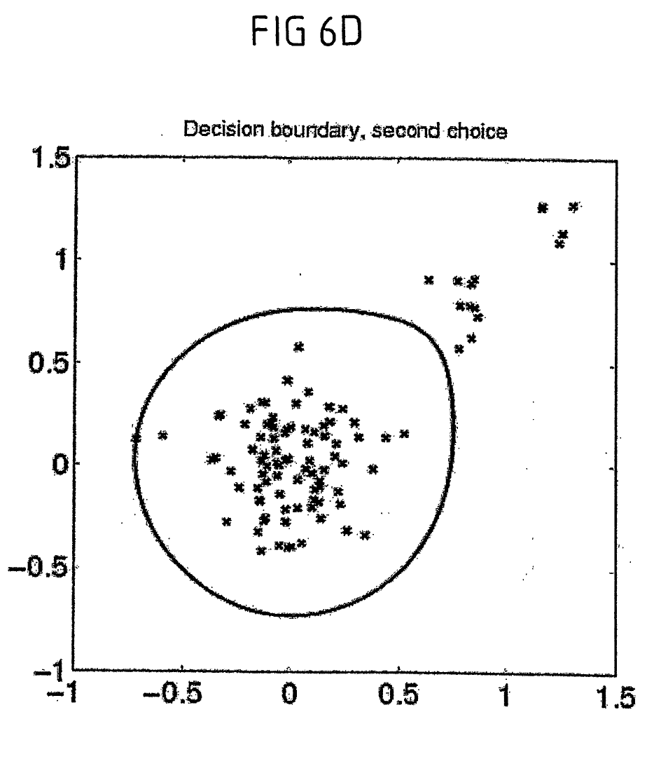

FIG. 6A-6D depicting the decision boundaries arising from two automatically selected anomaly ratios.

A system and method are disclosed for online detection and classification of anomalous objects in continuous data streams.

In FIG. 1 the data flow of one embodiment is depicted.

The overall scheme of an embodiment of the system and the method is depicted in FIG. 1. The input of the system is a data stream 1000 containing normal and anomalous objects pertaining to a particular application. In the following it is assumed that the data stream 1000 is incoming data of a computer network. The system according to the invention is used to detect anomalous objects in said data stream 1000 which could indicate a hacker attack.

The data stream 1000 are data packets in communication networks.

Alternatively the data stream 1000 can be entries in activity logs, measurements of physical characteristics of operating mechanical devices, measurements of parameters of chemical processes, measurements of biological activity, and others.

The central feature of the method and the system according to the invention is that it can deal with continuous data streams 1000 in an online fashion. The term “continuous” in this context means that data sets are received regularly or irregularly (e.g. random bursts) by the system and processed one at a time.

The term “online” in this context means that the system can start processing the incoming data immediately after deployment without the extensive setup and tuning phase. The tuning of the system is carried out automatically in the process of its operation. This contrasts with an offline mode in which the tuning phase involves extensive training (such as with the systems bases on neural networks and support vector machines) or manual interaction (such as with expert systems).

The system can alternatively operate in the offline mode, whereby the data obtained from the data stream 1000 are stored in the database 1100 before being using in the further processing stages. Such mode can employed in the situations when the volume of the incoming data exceeds the throughout of the processing system, and intermediate buffering in the database is required.

It is possible to operate the application in a mixed mode (e.g. in case the data is strongly irregular), in which at least a part of the total data stream is a continously incoming datastream 1000.

In this case, the system reads the data from the data stream 1000 as long is new data is available. If no new data is available, the system switches its input to the database and processes the previously buffered data. On the other hand, if the arrival rate of the data in the data stream 1000 exceeds the processing capacity of the system, the data is veered off into the database for processing at a later time. In this way, optimal utilization of computing resources is achieved.

Each of the incoming objects is supplied to a feature extraction unit 1200, which performs the pre-processing required to obtain the features 1300 relevant for a particular application.

The purpose of the feature extraction unit is to compute, based on the content of the data, the set of properties (“features”) suitable for subsequent analysis in an online anomaly detection engine 2000. These properties must meet the following requirements:

either

a) each property is a numeric quantity (real or complex), or

b) the set of properties forms a vector in an inner product space (i.e. computer programs are provided which take the said set of properties as arguments and perform the operations of addition, multiplication with a constant and scalar product pertaining to the said sets of properties), or

c) a non-linear mapping is provided transforming the sets of properties in the so-called Reproducing Kernel Hilbert Space (RKHS). The latter requirement can be satisfied by providing a computer program which takes the said sets of properties as arguments and computes a kernel function between the two sets of properties. The function realized by this program must meet (exactly or approximately) the conditions known as “Mercer conditions”.

In the exemplary embodiment of the system, the features can be (but are not limited to)
IP source address
IP destination address
TCP source port
TCP destination port
TCP sequence number
TCP acknowledgement number
TCP URG flag
TCP ACK flag
TCP PSH flag
TCP RST flag
TCP SYN flag
TCP FIN flag
TCP TTL field
start of the TCP connection
duration of the TCP connection
number of bytes transmitted from the source to the destination
number of bytes transmitted from the destination to the source

If the entire set of properties does not satisfy the imposed requirements as a whole, it can be split into subsets of properties. In this case, the subsets are processed by separate online anomaly detection engines.

Similarly to the data, the features can be buffered in the feature database 1400, if for some reason intermediate storage of features is desired.

Alternatively, if the incoming objects are such that they can be directly used in a detection/classification method, no feature extraction unit 1200 is necessary.

The features 1300 are then passed on to the online anomaly detection engine 2000.

The main step 2100 of the online anomaly detection engine 2000 comprises a construction and an update of a geometric representation of the notion of normality.

The online anomaly detection 2000 constitutes the core of the invention. The main principle of its operation lies in the construction and maintaining of a geometric representation of normality 2200. The geometric representation is constructed in the form of a hypersurface (i.e. a manifold in a high-dimensional space) which depends on selected examples contained in the data stream and on parameters which control the shape of the hypersurface. The examples of such hypersurfaces can be (but are not limited to):
a hyperplane
a hypersphere
a hyperellipsoid.

The online anomaly detection engine consists of the following components:
the unit for construction and update of the geometric representation 2100
the storage for the geometric representation 2200 produced by the unit 2100, and
the anomaly detection unit 2300.

The output of an online anomaly detection engine 2000 is an anomaly warning 3100 which can be used in the graphical user interface, in the anomaly logging utilities or in the component for automatic reaction to an anomaly. In the exemplary embodiment for identification of hacker attacks, the consumers of an anomaly warning are, respectively, the security monitoring systems, security auditing software, or network configuration software.

Alternatively, the output of an online anomaly detection engine can be used for futher classification of anomalies. Such classification is carried out by the classification unit 4000 which can utilize any known classification method, e.g. a neural network, a Support Vector Machine, a Fischer Discriminant Classifier etc. The anomaly classification message 4100 can be used in the same security management components as the anomaly warning.

In one embodiment the geometric representation of normality 2200 is a parametric hypersurface enclosing the smallest volume among all possible surfaces consistent with the pre-defined fraction of the anomalous objects (see example in FIG. 4 and 5).

Alternatively the geometric representation of normality 2200 is a parametric hypersurface enclosing the smallest volume among all possible surfaces consistent with a dynamically adapted fraction of the anomalous objects. An example is depicted in FIG. 6.

Said hypersurface is constructed in the feature space induced by a suitably defined similarity function between the data objects (“kernel function”) satisfying the conditions under which the said function acts as an inner product in the said feature space (“Mercer conditions”). The update of the said geometric representation of normality 2200 involves the adjustment so as to incorporate the latest objects from the incoming data stream 1000 and the adjustment so as to remove the least relevant object so as to retain the encapsulation of the smallest volume enclosed by the geometric representation of normality 2200, i.e. the hypersurface. This involves a minimization problem which is automatically solved by the system.

The construction and the update of the geometric representation of normality 2200 will be described in greater detail in connection with FIG. 2.

Once the geometric representation of normality 2200 is automatically updated, an anomaly detection 2300 is automatically performed by the online anomaly detection engine 2000 assigning to the object the
status of a normal object, if the object falls into the volume encompassed by the geometric representation of normality 2200, or
the status of an anomalous object, if the entry lies outside of the volume encompassed by the geometric representation of normality 2200.

The output of the online anomaly detection engine 2000 is used to issue the anomaly warning 3100 and/or to trigger the classification component 4000 which can utilize any known classification method such as decision trees, neural networks, support vector machines (SVM), Fischer discriminant etc.

The use of support vector machines in connection with the invention is described below in Appendix A.

The geometric representation of normality 2200 can also be supplied to the classification component if this is required by the method.

In an exemplary embodiment of the construction and update of the geometric representation of normality 2100 the hypersurface representing the class of normal events is represented by the set of parameters x₁, . . . , Xₙ (i=1 . . . n), one parameter for each object in the working set.

The size n of the working set is chosen in advance by the user There may be two reasons for this:
1. The data set is extremely large (tens of thousands examples), and maintaining all points in the equilibrium is computationally infeasible (too much memory is needed, or it takes too long). In this case, only the examples deemed most relevant should be kept around. The weights of examples are related to the relevance of examples for classification; therefore, the weights are used in the relevance unit to determine the examples to be excluded.
2.The data has temporal structure, and we believe that only the newest elements are relevant. In this case we should through out the oldest examples; this is what the relevance unit does if temporal structure is indicated.

The parameters are further restricted to be non-negative, and to have values less than or equal to C=1/(nν), where ν is the expected fraction of the anomalous events in the data stream (e.g. 0, 25 for 25% expected outliers), to be set by the user. This estimate is the only a à priori knowledge to be provided to the system. There may be some other, kernel-dependent parameters in the system. These parameters reflect some prior knowledge (if available) about the geometry of objects.

This is a very weak limitation since such estimates are readily available.

The working set it partitioned into the

“set 0” of the objects whose parameters xₖ are equal to zero,

“set E” of the object whose parameters xₖ are equal to C, and the

“set S” of the remaining objects.

The operation of the construction and update of the geometric representation of normality 2100 is illustrated in FIG. 2.

Upon the arrival of the data object k, the following three main actions are performed within a loop:
In step A2.5 the data entry is “imported” into the working set.
In step A2.6 the least relevant data object 1 is sought in the working set.
And in step A2.7 the data entry 1 is removed from the working set.

The importation and removal operations maintain the minimal volume enclosed by the hypersurface and consistent to the pre-defined expected fraction of anomalous objects.

For more complicated geometries a volume estimate can be used as the optimization criterion, since for more complicated surfaces such as the hyperellipsoid, the exact knowledge of a volume may not be available.

These operations are explained in more detail in Appendix C. The relevance of the data object can be judged either by the time stamp on the object or by the value of parameter xᵢ assigned to the object.

The steps A2.1 to A2.4 are the initialization operations to be performed when not enough data objects have been observed in order to bring the system into equilibrium (i.e. not enough data to construct a hypersurface).

Construction of the hypersurface 2200 enclosing the smallest volume and consistent with the pre-defined expected fraction of anomalous objects amounts, as shown in the article “Support Vector Data Description” by D. M. J. Tax and R. P. W. Duin, Pattern Recognition Letters, vol. 20, pages 1191-1.199, (1999), to solving the following mathematical programming problem:

$${max}_{μ} {min}_{{= \leq x \leq C}_{aTx + b = 0}} \text{:} W = {c}^{T} x + \frac{1}{2} {x}^{T} … {a}^{T} x + b , \qquad ( 1 )$$

where:

K is a n×n matrix that consists of evaluations of the given kernel function for all data points in the working set: K_{i,j}=kernel (pᵢ, pⱼ)

For example, of the objects are vectors in the n-dimentional space, and the solution is sought in the linear feature space, the kernel function is evaluated as follows:

$$kernel ( {p}_{i} , {p}_{j} ) = {\sum }_{k = 1}^{n} {p}_{i}^{k} {p}_{j}^{k}$$

As another example, if the solution is space in the features space of radial basis functions (which is n infinite-dimensional space, the kernel function is computed as:

$$kernel ( {p}_{i} , {p}_{j} ) = {exp}^{( \frac{‖ {p}_{i} - {p}_{j} ‖}{2 * γ} )}$$

where γ is the kernel parameter.

In equation (1) c is the vector of the numbers at the main diagonal of K, a is the vector of n ones and b=−1.

The parameter C is related to the expected fraction of the anomalous objects.

The necessary and sufficient condition for the optimality of the representation attained by the solution to problem (1) is given by the well-known Karush-Kuhn-Tucker conditions.

When all the points in the working set satisfy the said conditions, the working set is said to be in equilibrium.

Importation of a new data objects into, or removal of an existing data object from a working set may result in the violation of the said conditions. In such case, adjustments of the parameters x₁, . . . , xₙ are necessary, in order to bring the working set back into equilibrium.

An framework for performing such adjustments, based on the Karush-Kuhn-Tucker conditions, for a different mathematical programming problem—Support Vector Learning—was presented in the article “Incremental and Decremental Support Vector Learning” by G. Cauwenberghs and T. Poggio, Advances in Neural Information Processing Systems 13, pages 409-415, (2001).

The algorithms for performing the adjustments of the geometric representation are described in more detail in appendix C.

Special care needs to be taken at the initial phase of the operation of the online anomaly detection engine as described in FIG. 2. When the number of data objects in the working set. is less than or equal to 1/C (the greatest integer smaller than or equal to 1/C), equilibrium cannot be reached and the importation method cannot be applied.

The initialization steps A2.1 to A2.4 of the invention are designed to handle this special case and to bring the working set into the equilibrium after the smallest possible number of data objects has been seen.

The exemplary embodiment of the online anomaly detection method in the system for detection and classification, of computer intrusions is depicted in FIG. 3.

The online anomaly detection engine 2000 is used to analyse a data stream 1000 (audit stream) containing network packets and records in the audit logs of computers. The packets and records are the objects to be analysed.

The audit stream 1000 is input into the feature extraction component 1200 comprising a set of filters to extract the relevant features.

The extracted features are read by the online anomaly detection engine 2000 which identifies anomalous objects (packets or log entries) and issues an event warning if the event is discovered to be anomalous. Classification of the detected anomalous events is performed by the classification component 4000 previously trained to classify the anomalous events collected and stored in the event database.

The online anomaly detection engine comprises a processing unit having memory for storing the incoming data, the limited working set, and the geometric representation of the normal (non-anomalous) data objects by means of a parametric hypersurface; stored programs including the programs for processing of incoming data; and a processor controlled by the stored programs. The processor includes the components for construction and update of the geometric representation of normal data objects, and for the detection of anomalous objects based on the stored representation of normal data objects.

The component for construction and update of the geometric representation receives data objects and imports it into the representation such that the smallest volume enclosed by the hypersurface and consistent with the pre-defined expected fraction of anomalous objects is maintained; the component further identifies the least relevant entry in the working set and removes it while maintaining the smallest volume enclosed by the hypersurface. Detection of the anomalous objects is performed by checking if the objects fall within or outside of the hypersurface representing the normality.

As an embodiment of the invention, the architecture of the system for detection and classification of computer intrusions is disclosed. The system consists of the feature extraction component receiving data from the audit stream; of the online anomaly detection engine; and of the classification component, produced by the event learning engine trained on the database of appropriate events.

In FIG. 4 and 5 the construction of the geometrical representation of normality 2200 is described, especially in connection with the initialisation.

In order to find the optimal geometric representation of normality 2200 of a dataset with respect to the optimality criterion, a certain minimum number of objects is required. Referring to the above mentioned example (e.g. FIG. 3), this would mean that some incoming data of the computer network needs to be gathered.

Each object has an individual weight α₁, which is bounded by a parameter C. For the optimal representation the sum of the α₁ should be one. Given a very small set of objects, the optimality criteria cannot be fulfilled.

Consider a simple example, where a minimum number of seven objects is required (see FIG. 4A to 4C). When the first six objects, plotted by stars in figure FIG. 4A are given maximal weight C, the optimality criterion cannot be fulfilled.

Suppose the window size is 100 examples and the expected outlier ratio is 7%. One can compute the value of C= 1/7. In order to bring the system in equilibrium, all the constraints must be satisfied; that is, all a_i should be <= 1/7 but their sum should be equal to one. It can be easily seen that these two constraints can only be satisfied after we have observed at least 7 points.

After adding a seventh object, indicated by the circle in FIG. 4B, its weight, and the weights of the other objects can be optimized (i.e. subjected to a minimisation routine to find an geometric representation. In this two-dimensional dataset a closed curve around the objects enclosing a minimal area).

The new object increases its weight α, while one of the other objects decreases its weight α to maintain the overall sum of the weights. These two objects are indicated by the ‘x’ marks in FIG. 4B.

In the final step of the optimization, the added object hits the upper weight bound. This is indicated in FIG. 4C by the change of the marker to a star.

The meaning of the curve in this figure, as well as in all subsequent figures, is the shape of the representation of normality. Although it may seem somewhat strange that there are no points inside the normality region, it should be noted, however, that the guarantees as to the upper bound on the number anomalies can be fulfilled only after at least n=window_size points have been seen. Until then, although the feasible solution exists, the statistical features of this solution cannot be enforced.

In FIG. 5A to 5G the process of incorporating a new object to an existing classifier (i.e. an already existing geometric representation of normality 2200) is shown. As e.g. indicated in FIG. 5A there are some objects outside the closed curve 2200 which shows that those objects would be considered “anomalous”.

FIG. 5A shows a scatterplot of twenty objects. On this dataset a classifier is trained (i.e. a minimisation as indicated above), and the geometric representation of normality 2200 as a decision boundary is plotted.

The three types of data objects are indicated:
The dotted objects are the objects which are classified as target objects (i.e. “normal”). These objects are said to belong to the ‘rest’ set, or set R. These objects have weight 0.
The starred objects are objects rejected by the classifier (i.e. “anomalous”), and thus belong to the error set E. Their: weights have the maximum value of C.
Finally, the objects on the curve of the geometric representation of normality 2200 indicated by “x”, are the support vectors (belonging to set S) which have a non-zero weigth, but are not bounded.

In FIG. 5B, a new object is added at position (2, 0). This object is now added to the support set S, but the classifier is now out of equilibrium. In the following steps (see steps 2100, 2200, 2300 in FIG. 1) the weights and the set memberships of the other objects are automatically adapted. Until the system has reached the state of equilibrium, such geometric interpretation is not possible, which can be clearly seen starting from FIG. 5b. We have added the new object to set S, in order to be able to change its weight; however, the curve cannot be immediately forces to go through the new object, and furthermore, at the beginning of the importation of the new object we do not know if it should pass through the new object. In FIG. 5c and all subsequent figures the circle indicates the object that has changed its state. In the last figure, in which the new object has received its final state, one can see that the geometric representation is again consistent: the curve passes through the crosses and separates the stars (anomalies) from dots (normal points).

As can be seen from the above, the geometric representation of normality is updated sequentially which is essential for on-line (real time) applications. There are no prior assumptions about the classification. The classification (i.e. the membership to set) is developed automatically while the data is received.

In the next step (FIG. 5D), the same change is done by another object. After three more steps, the new equilibrium is obtained. Having this classifier, a new object can be processed now.

FIGS. 5D through 5G illustrate the progress of the algorithm and different possible state changes that the examples can undertake (see also by previous comment). In FIG. 5D the an object is removed from set S into set O. In FIG. 5E an object is added to set S from set E. In. FIG. 5F an object is removed from set S into set E. Finally, in FIG. 5G a current object is assigned to set E and the equilibrium is reached.

FIGS. 6A through 6D illustrate the case when the outlier ratio parameter ν is automatically selected from the data. In FIGS. 6A and 6B one can see the ranking measure computed for all data points. The local minima of this function are indicated by arrows, referred to as the “first choice” (the smallest minimum) and the “second choice” (the next smallest minimum). These minima yield the candidate values for the outlier ratio parameter, approximately 5% or 15%. The decision functions corresponding to these values are shown in FIGS. 6C a 6D.

In Appendix B, especially in section 2.4 a particular advantageous formulation of the geometric representation of normality (2200), i.e. the quarter sphere is described. The asymmetry of the geometric representation of normality (2200) is well suited for data-streams in intrusion problems.

For reasons of simplicity the inventive method and system is described in connection with a two-dimensional data set. Obviously the method and the system can be generalised to datasets with arbitrary dimensions. The curve would be a hypersurface enclosing a higher dimensional volume.

The invention is also applicable to monitoring of the measurements of physical parameters of operating mechanical devices, of the measurements of chemical processes and of the measurement of biological activity. In general the invention is specifically suited in situations in which continuous data is received and no à priori classification or knowledge about the source of the data is available.

Such an application is e.g. image analysis of medical samples where anomalous objects can be distinguished by a different colour or radiation pattern. Another possible medical application would be data streams representing electrical signals obtained from EEG or ECG apparatus. Here anomalous wave patterns can be automatically detected. Using EEG data the imminent occurrence of an epileptic seizure might be detected.

Furthermore, data online collected from mechanical or geophysical system can analysed using the inventive method and system. Mechanical stress and resulting fractures can be discerned from the data. As soon as “anomalous” data (i.e. deviations from “normal” data) is received, this might indicate a noteworthy chance of conditions.

The inventive method and system could also be applied to pattern recognition in which the pattern is not known à priori which is usually the case. The “anomalous” objects would be the ones not belonging to the pattern. There is also a possible application of the inventive method and system in connection with financial data. It could be used to identify changes in trading data indicating unwanted risks. Credit card data could be also analysed to identify risks or even fraud.

Appendix A describes a the general context of online SVM. Appendix B describes a special application using a quarter-sphere method. Appendix C contains the description some extra FIG. C2, C3, C5, C6, C7, C10, C11, C12. FIG. C2 gives general overview. Appendix D explains some of the formulae.

The paper presents two useful extensions of the incremental SVM in the context of online learning. An online support vector data description algorithm enables application of the online paradigm to unsupervised learning. Furthermore, online learning can be used in the large-scale classification problems to limit the memory requirements for storage of the kernel matrix. The proposed algorithms are evaluated on the task of online monitoring of EEG data, and on the classification task of learning the USPS dataset with a-priori chosen working set size.

Introduction

Many real-life machine learning problems can be more naturally viewed as online rather than batch learning problems. Indeed, the data is often collected continuously in time, and, more importantly, the concepts to be learned may also evolve in time. Significant effort has been spent in the recent years on development of online SVM learning algorithms (e.g. [17, 13, 7, 12]). The elegant solution to online SVM learning is the incremental SVM [4] which provides a framework for exact online learning. In the wake of this work two extensions to the regression SVM have been independently proposed [10, 9].

One should note, however, a significant restriction on the applicability of the above-mentioned supervised online learning algorithms: the labels may not be available online, as it would require manual intervention at every update step. A more realistic scenario is the update of the existing classifier when a new batch of data becomes available. The true potential of online learning can only be realized in the context of unsupervised learning.

An important and relevant unsupervised learning problem is one-class classification [11, 14]. This problem amounts to constructing a multi-dimensional data description, and its main application is novelty (outlier) detection. In this case online algorithms are essential, for the same reasons that made online learning attractive in the supervised case: the dynamic nature of data and drifting concepts. An online support vector data description (SVDD) algorithm based on the incremental SVM is proposed in this paper.

Looking back at the supervised learning, a different role can be seen for online algorithm. Online learning can be used to overcome memory limitations typical for kernel methods on large-scale problems. It has been long known that storage of the full kernel matrix, or even the part of it corresponding to support vectors, can well exceed the available memory. To overcome this problem, several subsampling techniques have been proposed [16, 1]. Online learning can provide a simple solution to the subsampling problem: make a sweep through the data with a limited working set, each time adding a new example and removing the least relevant one. Although this procedure results in an approximate solution, an experiment on the USPS data presented in this paper shows that significant reduction of memory requirements can be achieved without major decrease in classification accuracy.

To present the above-mentioned extensions we first need an abstract formulation of the SVM optimization problem and a brief overview of the incremental SVM. Then the details of our algorithms are presented, followed by their evaluation on real-life problems.

Problem Definition

A smooth extension of the incremental SVM to the SVDD can be carried out by using the following abstract form of the SVM optimization problem:

$${max}_{μ} {min}_{{= \leq x \leq C}_{aTx + b = 0}} \text{:} W = - {c}^{T} x + \frac{1}{2} {x}^{T} Kx + μ ( {a}^{T} x + b ) , \qquad ( 1 )$$

where c and a are n×1 vectors, K is a n×n matrix and b is a scalar. By defining the meaning of the abstract parameters a, b and c for the particular SVM problem at hand, one can use the sane algorithmic structure for different SVM algorithms. In particular, for the standard support vector classifiers [19], take c=1, a=y, b=0 and the given regularization constant C; the same definition applies to the ν-SVC [15] except that

$$C = \frac{1}{Nv} ;$$

for the SVDD [14, 18], the parameters are defined as: c=diag(K), a=y and b=−1.

Incremental (decremental) SVM provides a procedure for adding (removing) one example to (from) an existing optimal solution. When a new point k is added, its weight xₖ is initially assigned to 0. Then the weights of other points and μ should be updated, in order to obtain the optimal solution for the enlarged dataset. Likewise, when a point k is to be removed from the dataset, its weight is forced to 0, while updating the weights of the remaining points and μ so that the solution obtained with xₖ=0 is optimal for the reduced dataset. The online learning follows naturally from the incremental/decremental learning: the new example is added while some old example is removed from the working set.

Incremental SVM: An Overview

Main idea

The basic principle of the incremental SVM (4) is that updates to the state of the example k should keep the remaining examples in their optimal state. In other words, the Kuhn-Tucker (KT) conditions:

$$\begin{matrix}{g}_{i} - {c}_{i} + {K}_{i} x + μ {a}_{i} \{ \begin{matrix}\geq 0 & if {x}_{i} = 0 \\ = 0 , & if 0 {<}_{i} < C \\ \leq 0 , & if {x}_{i} = C\end{matrix} & ( 2 ) \\ \frac{\partial W}{\partial μ} = {a}^{T} x + b = 0 & ( 3 )\end{matrix}$$

must be maintained for all the examples, except possibly for the current one.

To maintain optimality in practice, one can write out conditions (2)-(3) for the states before and after the update of xₖ. By subtracting one from the other the following condition on increments of Δx and Δg is obtained:

$$[ \begin{matrix}Δ {g}_{k} \\ Δ {g}_{g} \\ Δ {g}_{r} \\ 0\end{matrix} ] = [ \begin{matrix}{a}_{k} & {K}_{ks} \\ {a}_{s} & {K}_{ss} \\ {a}_{r} & {K}_{rs} \\ 0 & {a}_{s}^{T}\end{matrix} ] \underbrace{[ \begin{matrix}Δ μ \\ Δ {x}_{s}\end{matrix} ]}_{Δ σ} + [ \begin{matrix}{K}_{kk}^{T} \\ {K}_{kk}^{T} \\ {K}_{kr}^{T} \\ {a}_{k}\end{matrix} ] Δ {x}_{k} . \qquad ( 4 )$$

The subscript s refer to the examples in the set S of unbounded support vectors, and the subscript r refers to the set R of bounded support vectors (E) and other examples (O). It follows from (2) that Δgₐ=0. Then lines 2 and 4 of the system (4) can be re-written as:

$$[ \begin{matrix}0 \\ 0\end{matrix} ] = [ \begin{matrix}0 & {a}_{s}^{T} \\ {a}_{s} & {K}_{ss}\end{matrix} ] Δ s + [ \begin{matrix}{a}_{k} \\ {K}_{ks}^{T}\end{matrix} ] Δ {x}_{k} . \qquad ( 5 )$$

This linear system is easily solved for Δs:

$$\begin{matrix}Δ s = β Δ {x}_{k} , \\ where & ( 6 ) \\ β = - \underbrace{{[ \begin{matrix}0 & {a}_{s}^{T} \\ {a}_{s} & {K}_{ss}\end{matrix} ]}^{- 1}}_{α} \underbrace{[ \begin{matrix}{a}_{k} \\ {K}_{ks}^{T}\end{matrix} ]}_{η} & ( 7 )\end{matrix}$$

is the gradient of the linear manifold of optimal solutions parameterized by xₖ.

One can further substitute (6) into the lines 1 and 3 of the system (4) and obtain the following relation:

$$\begin{matrix}[ \begin{matrix}Δ {g}_{k} \\ Δ {g}_{r}\end{matrix} ] = γ Δ {x}_{b} , \\ where & ( 8 ) \\ γ = [ \begin{matrix}{a}_{c} & {K}_{k θ} \\ {a}_{r} & {K}_{rs}\end{matrix} ] β + [ \begin{matrix}{K}_{kk} \\ {K}_{kr}^{T}\end{matrix} ] & ( 9 )\end{matrix}$$

is the gradient of the linear manifold of the gradients of the examples in set R at the optimal solution parameterized by xₖ.
Accounting: A Systematic Account

Notice that all the reasoning in the preceding section is valid only for sufficiently small Δxₖ such that the composition of sets S and R does not change. Although computing the optimal Δxₖ in not possible in one step, one can compute the largest update Δxₖ^{max} such that composition of sets S and R remains intact. Four cases must be accounted for¹:
1. Some xᵢ in S reaches a bound (upper or lower one). Let ε be a small number. Compute the sets²
I₊^{S}={iεS: sign (Δxᵢ)βᵢ>ε}
I₋^{S}={iεS: sign (Δxₖ)βᵢ<−ε}.
The examples in set I₊^{s} have positive sensitivity with respect to the current example; that is, their weight would increase by taking a step Δxₖ. These examples should be tested for reaching the upper bound C. Likewise, the examples in set I₋^{s} should be tested for reaching 0. The examples with −ε<βᵢ<e can be ignored, as they are insensitive to Δxₖ. Thus the possible weight updates are:

$$Δ {x}_{i}^{max} = \{ \begin{matrix}C - {x}_{i} , & if i ∈ {I}_{+}^{S} \\ - {x}_{i} , & if i ∈ {I}_{-}^{S} ,\end{matrix}$$

and the largest possible Δxₖ^{s} before one of the elements in S reaches a bound is:

$$Δ {x}_{k}^{s} = {abs min}_{x ∈ {I}_{+}^{S} ⋃ {I}_{-}^{S}} \frac{Δ {x}_{i}^{max}}{{β}_{i}} , \\ where \\ {abs min}_{i} ( x ) := {min}_{i} \vert {x}_{i} \vert \cdot sign ( {x}_{( {argmin}_{i} \vert {x}_{i} \vert )} ) . \qquad ( 10 )$$

¹ In the original work of Cauwenberghs and Poggio five cases are used but two of them easily fold together.

² Note that sign (Δxₖ) is +1 for the incremental and −1 for the decremental cases.
2. Some gᵢ in R reaches zero. Compute the sets
   I₊^{R}={iεE: sign(Δxₖγᵢ>e}
   I₋^{R}={iεO: sign(Δxₖ)γᵢ<−ε}.
The examples in set I₊^{R} have positive sensitivity of the gradient with respect to the weight of the current example. Therefore their (negative) gradients can potentially reach 0. Likewise, gradients of the examples in set I₋⁴ are positive but are pushed towards 0 with the changing weight of the current example. Only points in I₊^{R}UI₋^{R} need to be considered for computation of the largest update ΔIₖ^{R}:

$$Δ {x}_{k}^{R} = {abs min}_{i ∈ {I}_{+}^{R} ⋃ {I}_{-}^{n}} \frac{- {g}_{i}}{{γ}_{i}} . \qquad ( 11 )$$
3. gₖ becomes 0. This case is similar to case 2, except that feasibility test becomes:
   sign(Δxₖ)γₖ>ε,
and if it holds, the largest update Δxₖ^{g} is computed as:

$$Δ {x}_{k}^{g} = \frac{- {g}_{k}}{{γ}_{k}} . \qquad ( 12 )$$
4. xₖ reaches the bound. The largest possible increment is clearly

$$Δ {x}_{k}^{s} = \{ \begin{matrix}C - {x}_{k} , & if {x}_{k} is added \\ - {x}_{k} , & if {x}_{k} is removed .\end{matrix} \qquad ( 13 )$$

Finally, the largest possible update is computed among the four cases:
Δxₖ^{max}=absmin([Δxₖ^{s}; Δxₖ^{R}Δxₖ^{g}; Δxₖ^{x}]).

The rest of the incremental SVM alogrithm essentially consists of repeated computation of the update Δxₖ^{max}, update of the sets S, E and O, update of the state and of the sensitivity parameters β and γ. The iteration stops when either case 3 or case 4 occurs in the increment computation. Computational aspects of the algorithm can be found in [4].

Special Case: Empty Set S

Applying this incremental algorithm leaves open the possibility of an empty set S. This has two main consequences. First, all the blocks with the subscript s vanish from the KT conditions (4). Second, it is be impossible to increase the weight of the current example since this would violate the equality constraint of the SVM. As a result, the KT conditions (4) can be written component-wise as
Δgₖ=αₖΔμ (15)
Δgᵣ=αᵣΔμ. (16)
One can see that the only free variable is Δμ, and [aₖ; α₄] plays the role of sensitivity of the gradient with respect to Δμ. To select the points from E or O which may enter set S, a feasibility relationship similar to the main case, can be derived. Resolving (15) for Δμ and substituting the result into (16), we conclude that

$$Δ {g}_{r} = - \frac{{a}_{r}}{{a}_{k}} Δ {g}_{{k}^{-}}$$

Then, using the KT conditions (2), the feasible index sets can be defined as

$$\begin{matrix}{I}_{+} = \{ i ∈ E : - \frac{{a}_{i}}{{a}_{k}} {g}_{k} > ε \} & ( 17 ) \\ {I}_{-} = \{ i ∈ O : - \frac{{a}_{i}}{{a}_{k}} {g}_{k} < ε \} & ( 18 )\end{matrix}$$

and the largest possible step Δμ^{max} can be computed as;

$$Δ {μ}^{max} = {abs min}_{i ∈ {I}_{+} ⋃ {I}_{-} ⋃ k} \frac{- {g}_{i}}{{a}_{i}} \qquad ( 19 )$$

Online SVDD

As it was mentioned in the introduction, the online SVDD algorithm uses the same procedure as the incremental SVM, with the following definitions of the abstract parameters in problem (1): c=diag(K), α=y and b=−1. However, special care needs to be taken of the initialization stage, in order to obtain the initial feasible solution.

Initialization

For the standard support vector classification, an optimal solution for a single point is possible; x₁=0, b=y₁. In the incremental SVDD the situation is more complicated. The difficulty arises from the fact that the equality constraint

$${\sum }_{i = 1}^{n} {a}_{i} {x}_{i} = 1$$

and the box constraint 0≦xᵢ≦C may be inconsistent; in particular, the constraint cannot be satisfied when fewer than ┌1/C┐ examples are available. This initial solution can be obtained by the following procedure:
1. Take the first └1/C┘ objects, assign them weight C and put them in E.
2. Take the next object k, assign it

$${x}_{k} = 1 - ⌊ \frac{1}{C} ⌋ C$$

and put it in S.
3. Compute the gradients gᵢ of all objects, using (2). Compute μ such that for all objects in E the gradient is less than or equal to zero:

$$μ = - {max}_{i ∈ E} {g}_{i} \qquad ( 20 )$$
4. Enter the main loop of the incremental algorithm. [image]
   Experiments on BCI Data

This experiments shows the use of the online novelty detection task on non-stationary time series data. The online SVDD is applied to a BCI (Brain-Computer-Interface) project [2, 3]. A subject was sitting in front of a computer, and was asked to press a key on the keyboard using the left or the right hand. During the experiment, the EEG brain signals of the subject are recorded. From these signals, it is the task to predict which hand will be used for the key press. The first step in the classification task requires a distinction between ‘movement’ and ‘no-movement’ which should be made online. The incremental SVDD will be used to characterize the normal activity of the brain, such that special events, like upcoming keystroke movements, are detected.

After preprocessing the EEG signals, at each time point the brain activity is characterized by 21 feature values. The sampling rate was reduced to 10 Hz. A window of 500 time points (thus 5 seconds long) at the start of the time series was used to train an SVDD. In the top plot of FIG. 1 the output of this SVDD is shown through time. For visualization purposes just a very short, but characteristic part of the time series is shown. The dotted line with the regular single peaks indicates the times at which a key was pressed. The output of the classifier is shown by the solid noisy line. When this line exceeds zero, an outlier, or deviation from the normal situation is detected. The dashed line at the bottom of the graph, shows the muscular activity at the eyes. The large spikes indicate eye blinks, which are also detected as outliers. It appears that the output of the static classifier through time is very noisy. Although it detects some of the movements and eye blinks, it also generates many false alarms.

In the bottom plot of FIG. 1 the output of the online SVDD classifier is

TABLE 1
TEST CLASSIFICATION ERRORS ON THIS USPS DATASET,
USING A SUPPORT VECTOR CLASSIFIER (RBF
KERNEL, σ² = 0.3 · 256) WITH JUST M OBJECTS.

| | M | | | | | | | |
|---|---|---|---|---|---|---|---|---|
| | 50 | 100 | 150 | 200 | 250 | 300 | 500 | ∞ |
| error (%) | 25.41 | 6.88 | 4.68 | 4.48 | 4.43 | 4.38 | 4.29 | 4.25 |

shown. Here again, an output above zero indicates that an outlier is detected. It is clear that the online-version generates less false alarms, because it follows the changing data distribution. Although the detection is far from perfect, as can be observed, many of the keystrokes are indeed clearly detected as outliers. It is also clear that the method is easily triggered by the eye blinks. Unfortunately the signal is very noisy, and it is hard to quantify the exact periods for these methods on this data.
Online Learning in Large Datasets

To make the SVM learning applicable to very large datasets, the classifier has to be constrained to have a limited number of objects in memory. This is, in principle, exactly what an online classifier with fixed window size M does. The only difference is that removing the oldest object is not useful in this application because the same result is achieved as if the learning had been done on the last M objects. Instead, the “least relevant” object needs to be removed during each window advancement. A reasonable criterion for relevance seems to be the value of the weight. In the experiment presented below the example with the smallest weight is removed from the working set.

Experiments on the USPS Data

The dataset is the standard US Postal Service dataset, containing 7291 training and 2007 images of handwritten digits, size 16×16 [19]. On this 10 class dataset 10 support vector classifiers with a RBF kernel, σ²=0.3·256 and C=100, were trained³. During the evaluation of a new object, it is assigned to the class corresponding to the classifier with the largest output. The total classification error on the test set for different window sizes M is shown in table 1.
³The best model parameters as reported in [19] were used.

One can see that the classification accuracy deteriorates marginally (by about 10%) until the working size of 150, which is about 2% of the data. Clearly, by discarding “irrelevant” examples, one removes potential support vectors that cannot be recovered at a later stage. Therefore it is expected that performance of the limited memory classifier would be worse than that of an unrestricted classifier. It is also obvious that no more points than the number of support vectors are eventually needed, although the latter number is not known in advance. The average number of support vectors per each unrestricted 2-class classifier in this experiment is 274. Therefore the results above can be interpreted as reducing the storage requirement by 46% from the minimal at the cost of 10% increase of classification problem.

Notice that the proposed strategy differs from the caching strategy, typical for many SVM^{light}-like algorithms 16, 8, 5], in which kernel products are re-computed if the examples are found missing in the fixed-size cache and the accuracy of the classifier is not sacrificed. Our approach constitutes a trade-off between accuracy and computational load because kernel products never need to be re-computed. It should be noted, however, that computational cost of re-computing the kernels can be very significant, especially for the problems with complicated kernels such as string matching or convolution kernels.

Conclusions

Based on revised verson of the incremental SVM, we have proposed; (a) an online SVDD algorithm which, unlike all previous extensions of incremental SVM, deals with an unsupervised learning problem, and (b) a fixed-memory training algorithm for the classification SVM which allows to limit the memory requirement for storage of the kernel matrix at the expense of classification performance. Experiments on novelty detection in non-stationary time series and on the USPS dataset demonstrate feasibility of both approaches. More detailed comparisons with other subsampling techniques for limited-memory learning will be carried out in future work.

Acknowledgements

This research was partially supported through a European Community Marie Curie Fellowship and BMBF FKZ 01IBB02A. We would like to thank K.-R. Müller and B. Blankertz for fruitful discussions and the use of BCI data. The authors are solely responsible for information communicated and the European Commission is not responsible for any views or results expressed.

### REFERENCES

[1] D. Achlioptas, F. McSherry and B. Schölkopf, “Sampling Techniques for Kernel Methods,” in T. Diettrich, S. Becker and Z. Ghabramani (eds.), Advances in Neural Information Proccessing Systems, 2002, vol. 14, pp. 335-341.
]2] B. Blankertz, G. Curio and K.-R. Müller, “Classifying Single Trial EEG: Towards Brain Computer Interfacing,” in T. G. Diettrich, S. Becker and Z. Ghahramani (eds.), Advances in Neural Inf. Proc. System (NIPS 01), 2002, vol. 14, pp. 157-164.
[3] B. Blankertz, G. Dornhege, O. Schäfer, R. Krepki, J. Kohlmorgen, K.-R. Müller, V. Kunzmann, F. Losch and G. Curio, “BCI bit rates and error detection for fast-pace motor commands based on single-trial EEG analysis,” IEEE Transactions on Rehabilitation Engineering, 2003, accepted.
[4] G. Cauwenberghs and T. Poggio, “Incremental and decremental support vector machine learning,” in Neural Information Processing Systems, 2000.
[5] R. Collobert and S. Bengio, “SVMTorch: Support vector machines for large-scale regression problems,” Journal of Machine Learning Research, vol. 1, pp. 143-160, 2001.
[6] T. Joachims, “Making Large-Scale SVM Learning Practical,” in B. Schölkopf, C. Burges and A. Smola (eds.), Advances in Kernel Methods—Support Vector Learning, Cambridge, Mass.: MIT Press, 1999, pp. 169-184.

[7] J. Kivinen, A. Smola and R. Williamson, “Online learning with kernels,” in T. G. Diettrich, S. Becker and Z. Ghahramani (eds.), Advances in Neural Inf. Proc. Systems (NIPS 01), 2001, pp. 785-792.
[8] P. Laskov, “Feasible direction decomposition algorithms for training support vector machines,” Machine Learning, vol. 46, pp.315-349, 2002.
[9] J. Ma, J. Theiler and S. Perkins, “Accurate online support vector regression,” http://nis-www.lanl.gov/jt/Papers/aoβvr.pdf.
[10] M. Martin, “On-line Support Vector Machines for function approximation,” Techn. report, Universitat Politècnica de Catalunya, Departament de Llengatges i Sistemes Informàtics, 2002.
[11] M. Moya and D. Husb, “Network constraints and multi-objective optimization for one-class classification,” Neural Networks, vol. 9, no. 3, pp. 463-474, 1996.
[12] L. Ralaivola and F. d'Alché Buc, “Incremental Support Vector Machine Learning: A Local Approach,” Lecture Notes in Computer Science, vol. 2130, pp. 322-329, 2001.
[13] S. Rüping, “Incremental learning with support vector machines,” Techn. Report TR-18, Universität Dortmund, SFB475, 2002.
[14] B. Schölkopf, J. Platt, J. Shawe-Taylor, A. Smola aud R. Williamson, “Estimating the support of a high-dimensional distribution,” Neural Computation, vol. 13, no. 7, pp. 1443-1471, 2001.
[15] B. Schölkopf, A. Smola, R. Williamson and P. Bartlett, “New Support Vetor Algorithrms,” Neural Computation, vol. 12, pp. 1207-1245, 2000, also NeuroCOLT Technical Report NC-TR-1998-031.
[16] A. Smola and B. Schölkopf, “Sparse greedy matrix approximation for machine learning,” in P. Langley (ed.), Proc. ICML '00, S” San Francisco: Morgan Kaufmann, 2000, pp. 911-918.
[17] N. A. Syed, F. Liu and K. K. Sung, “Incremental learning with support vector machines,” In SVM workshop, IJCAI, 1999.
[18] D. Tax and R. Duin, “Uniform object generation for optimizing one-class classifiers,” Journal for Machine Learning Research, pp. 155-173, 2001.
[19] V. Vapnik, Statistical Learning Theory, New York. Wiley, 1998.

Practical application of data mining and machine learning techniques to intrusion detection is often hindered by the difficulty to produce clean data for the training. To address this problem a geometric framework for unsupervised anomaly detection has been recently proposed. In this framework, the data is mapped into a feature space, and anomalies are detected as the entries in sparsely populated regions. In this contribution we propose a novel formulation of a one-class Support Vector Machine (SVM) specially designed for typical IDS data features. The key idea of our “quarter-sphere” algorithm is to encompass the data with a hypersphere anchored at the center of mass of the data in feature space. The proposed method and its behavior on varying percentages of attacks in the data is evaluated on the KDDCup 1999 dataset.

1 Introduction

The majority of current intrusion detection methods can be classified as either misuse detection or anomaly detection [NWY02]. The former identify patterns of known illegitimate activity; the latter focus on unusual activity patterns. Both groups of methods have their advantages and disadvantages. Misuse detection methods are generally more accurate but are fundamentally limited to known attacks. Anomaly detection methods are usually less accurate than misuse detecion methods—in particular, their false alarm rates are hardly acceptable in practice—however, they are at least in principle capable of detecting novel attacks. This feature makes anomaly detection methods the topic of active research.

In some early approaches, e.g. [DR90, LV92], it was attempted to describe the normal behavior by means of some high-level rules. This turned out to be quite a difficult task. More successful was the idea of collecting data from normal operation of a system and computing, based on this data, features describing normality; deviation of such features would be considered an anomaly. This approach is known as “supervised anomaly detection”. Different techniques have been proposed for characterizing the concept of normality, most notably statistical techniques, e.g. [De87, JLA +93, PN97, WFP99], and data mining techniques, e.g. [BCJ⁺01, VS00]. In practice, however, it is difficult to obtain clean data to implement these approaches. Verifying that no attacks are present in the training data may be an extremely tedious task, and for large samples this is infeasible. On the other hand, if the “contaminated” data is treated as clean, intrusions similar to the ones present in the training data will be accepted as normal patterns.

To overcome the difficulty in obtaining clean data, the idea of unsupervised anomaly detection has been recently proposed and investigated on several intrusion detection problems [PES01, EAP⁺02, LEK⁺03]. These methods compute some relevant features and use techniques of unsupervised learning to identify sparsely populated areas in feature space. The points—whether in the training or in the test data—that fall into such areas are treated as anomalies.

More precisely, two kinds of unsupervised learning methods have been investigated: clustering methods and one-class SVM. In this contribution we focus on one-class SVM methods and investigate the application of the underlying geometric ideas in the context of intrusion detection.

We present three formulations of one-class SVM that can be derived following different geometric intuitions. The formulation used in previous work was that of the hyperplane separating the normal data from the origin [SPST⁺01]. Another formulation, motivated by fitting a sphere over the normal data, is also well-known in the literature on kernel methods [TD99]. The novel formulation we propose in this paper is based on fitting a sphere centered at the origin to normal data. This formulation, to be refered to as a quarter-sphere, is particularly suitable to the features common in intrusion detection, whose distributions are usually one-sided and concentrated at the origin.

Finally, we present an experimental evaluation of the one-class SVM methods under a number of different scenarios.

2 One-Class SVM Formulations

Support Vector Machines have received great interest in the machine learning community since their introduction in the mid-1990s. We refer the reader interested in the underlying statistical learning theory and the practice of designing efficient SVM learning algorithms to the well-known literature on kernel methods, e.g. [Va95, Va98, SS02]. The one-class SVM constitutes the extension of the main SVM ideas from supervised to unsupervised learning paradigms.

We begin our investigation into the application of the one-class SVM for intrusion detection with a brief re-capitulation and critical analysis of the two known approaches to one-class SVM. It will follow from this analysis that the quarter-sphere formulation, described in section 2.4, could be better suited for the data common in intrusion detection problems.

2.1 The Plane Formulation

The original idea of the one-class SVM [SPST⁺01] was formulated as an “estimation of the support of a high-dimensional distribution”. The essense of this approach is to map the data points xᵢ into the feature space by some non-linear mapping Φ(xᵢ), and to separate the resulting image points from the origin with the largest possible margin by means of a hyperplane. The geometry of this idea is illustrated in FIG. 1. Due to nonlinearity of [image]
feature space, maximization of the separation margin limits the volume occupied by the normal points to a relatively compact area in feature space. Mathematically, the problem of separating the data from the origin with the largest possible margin is formulated as follows:

$$\begin{matrix}{min}_{w ∈ ℱ , ξ ∈ {ℝ}^{1} , r ∈ ℝ} & \frac{1}{2} {‖ w ‖}^{2} + \frac{1}{vl} {\sum }_{i = 1}^{l} {ξ}_{i} - r , \\ subject to \text{:} & ( w \cdot Φ ( {x}_{i} ) ) \geq r - {ξ}_{i} , \\ & {ξ}_{i} \geq 0.\end{matrix} \qquad ( 1 )$$

The weight vector w, characterizing the hyperplane, “lives” in the feature space [symbol] , and therefore is not directly accessible (as the feature space may be extremely high-dimensional). The non-negative slack variables ξᵢ allow for some points, the anomalies, to lie on the “wrong” side of the hyperplane. Instead of the primal problem (1), the following dual problem, in which all the variables have low dimensions, is solved in practice:

$$\begin{matrix}{min}_{α ∈ {ℝ}^{1}} & {\sum }_{ij = 1}^{l} {α}_{i} {α}_{j} k ( {x}_{i} , {x}_{j} ) , \\ subject to \text{:} & {\sum }_{i = 1}^{l} {α}_{i} = 1 , \\ & 0 \leq {α}_{i} \leq \frac{1}{vl} .\end{matrix} \qquad ( 2 )$$

Once the solution α is found, one can compute the threshold parameter r=Σⱼαⱼk(xᵢ, xⱼ) for some example i such that αᵢ lies strictly between the bounds (such points are called support vectors). The decision, whether or not point x is normal, is computed as:

$$f ( x ) = sgn ( {\sum }_{i} {α}_{i} k ( {x}_{i} , x ) - r ) . \qquad ( 3 )$$

The points with f(x)=−1 are considered to be anomalies.
2.2 The Sphere Formulation

Another, somewhat more intuitive geometric idea for the one-class SVM is realized in the sphere formulation [TD99]. The normal data can be concisely described by a sphere (in a feature space) encompassing the data, as shown in FIG. 2. The presence of anomalies in the [image]
training data can be treated by introducing slack variables ξᵢ, similarly to the plane formulation. Mathematically the problem of “soft-fitting” the sphere over the data is described as:

$$\begin{matrix}{min}_{R ∈ ℝ , ξ ∈ {ℝ}^{1} , c ∈ ℱ} & {R}^{2} + \frac{1}{vl} {\sum }_{i = 1}^{l} {ξ}_{i} , \\ subject to \text{:} & ‖ Φ ( {x}_{i} ) - c ‖ \leq {R}^{2} + {ξ}_{i} , \\ & {ξ}_{i} \geq 0.\end{matrix} \qquad ( 4 )$$

Similarly to the primal formulation (1) of the plane one-class SVM, one cannot directly solve the primal problem (4) of the sphere formulation, since the center c belongs to the possibly high-dimensional feature space. The same trick can be employed—the solution is sought to the dual problem:

$$\begin{matrix}{min}_{α ∈ {ℝ}^{1}} & {\sum }_{ij = 1}^{l} {α}_{i} {α}_{j} k ( {x}_{i} , {x}_{j} ) - {\sum }_{i = 1}^{l} {α}_{i} k ( {x}_{i} , {x}_{i} ) , \\ subject to \text{:} & {\sum }_{i = 1}^{l} {α}_{i} = 1 , \\ & 0 \leq {α}_{i} \leq \frac{1}{vl} .\end{matrix} \qquad ( 5 )$$

The decision function can be computed as:

$$f ( x ) = sgn ( {R}^{2} - {\sum }_{ij = 1}^{l} {α}_{i} {α}_{j} k ( {x}_{i} , {x}_{j} ) + 2 {\sum }_{i = 1}^{l} {α}_{i} k ( {x}_{i} , x ) - k ( x , x ) ) . \qquad ( 6 )$$

The radius R² plays the role of a threshold, and, similarly to the plane formulation, it can be computed by equating the expression under the “sgn” to zero for any support vector. The similarity between the plane and the sphere formulations goes beyond merely an analogy. As it was noted in [SPST⁺01], for kernels k(x, y) which depend only on the difference x−y, the linear term in the objective function of the dual problem (5) is constant, and the solutions are equivalent.
2.3 Analysis

When applying one-class SVM techniques to intrusion detection problems, the following observation turns out to be of crucial importance: A typical distribution of the features used in IDS is one-sided on R₀⁺. Several reasons contribute to this property. First, many IDS features are of temporal nature, and their distribution can be modeled using distributions common in survival data analysis, for example by an exponential or a Weibull distribution. Second, a popular approach to attain coherent normalization of numerical attributes is the so-called “data-dependent normalization” [EAP ⁺02]. Under this approach, the features are defined as the deviations from the mean, measured in the fraction of the standard deviation. This quantity can be seen as F-distributed. Summing up, the overwhelming mass of data lies in the vicinity of the origin. The consequences of the one-sidedness of the data distribution for the one-class SVM can be seen in FIG. 3. The one-sided distribution in the example is generated by taking the

[image]

absolute values of the normally distributed points. The anomaly detection is shown for a fixed value of the parameter ν and varying smoothness σ of the RBF kernel. The contours show the separation between the normal points and anomalies. One can see that even for the heavily regularized separation boundaries, as in the right picture, some points close to the origin are detected as anomalies. As the regularization is diminished, the one-class SVM produces a very ragged boundary and does not detect any anomalies.

The message that can be carried from this example is that, in order to account for the one-sidedness of the data distribution, one needs to use a geometric construction that is in some sense asymmetric. The new construction we propose here is the quarter-sphere one-class SVM described in the next section.

2.4 The Quarter-Sphere Formulation

A natural way to extend the ideas of one-class SVM to one-sided non-negative data is to require the center of the fitted sphere be fixed at the origin. The geometry of this approach is shown in FIG. 4. Repeating the derivation of the sphere formulation for c=0, the [image]
following dual problem is obtained:

$$\begin{matrix}{min}_{α ∈ {ℝ}^{1}} & {\sum }_{i = 1}^{l} {α}_{i} k ( {x}_{i} , {x}_{i} ) , \\ subject to \text{:} & {\sum }_{i = 1}^{l} {α}_{i} = 1 , \\ & 0 \leq {α}_{i} \leq \frac{1}{vl} .\end{matrix} \qquad ( 7 )$$

Note that, unlike the other two formulations, the dual problem of the quarter-sphere SVM amounts to a linear rather than a quadratic program. Herein lies the key to the significantly lower computational cost of our formulation.

It may seem somewhat strange that the non-linear mapping affects the solution only through the norms k(xᵢ, xᵢ) of the examples, i.e. that the geometric relations between the objects are ignored. This feature indeed poses a problem for the application of the quarter-sphere SVM with the distance-based kernels. In such case, the norms of the points are equal, and no meaningful solution to the dual problem can be found. This predicament, however, can be easily fixed. A well-known technique, originating from kernel PCA [SSM98], is to center the images of the training points Φ(xᵢ) in feature space. In other words, the values of image points are re-computed in the local coordinate system anchored at the center of mass of the image points. This can be done by subtracting the mean from all image values:

$$\overline{Φ} ( {x}_{i} ) = Φ ( {x}_{i} ) - \frac{1}{l} {\sum }_{i = 1}^{l} Φ ( {x}_{i} ) .$$

Although this operation may not be directly computable in feature space, the impact of centering on the kernel values can be easily computed (e.g. [SSM98, SMB⁺99]):
K̅=K−1ₗK−K1ₗ+1ₗK1ₗ, (8)
where K is the l×l kernel matrix with the values Kᵢⱼ=k(xᵢ, xⱼ), and 1ₗ is an l×l matrix with all values equal to 1/l. After centering in feature space, the norms of points in the local coordinate system are no longer all equal, and the dual problem of the quarter-sphere formulation can be easily solved.
3 Experiments

To compare the quarter-sphere formulation with the other one-class SVM approache, and to investigate some properties of our algorithm, experiments are carried out on the KDDCup 1999 dataset. This dataset comprises connection record data collected in 1998 DARPA IDS evaluation. The features characterizing these connection records are pre-computed in the KDDCup dataset.

One of the problems with the connection record data from the KDDCup/DARPA data is that a large proportion (about 75%) of the connections represent the anomalies. In previous work [PES01, EAP⁺02] it was assumed that anomalies constitute only a small fraction of the data, and the results are reported on subsampled datasets, in which the ratio of anomalies is artificially reduced to 1-1.5%. To render our results comparable with previous work we also subsample the data. The results reported below are averaged over 10 runs of the algorithms in any particular setup.

3.1 Comparison of One-Class SVM Formulations

We first compare the quarter-sphere one-class SVM with the other two algorithms. Since the sphere and the plane formulations are equivalent for the RBF kernels, identical results are produced for these two formulations.

The experiments are carried out for two different values of the parameter a of the RBF kernel: 1 and 12 (the latter value used in [EAP⁺02]). These values correspond to low and moderate regularization. As the evaluation criterion, we use the portion of the ROC curve between the false alarm rates of 0 and 0.1, since higher false alarm rates are unacceptable for intrusion detection. The comparison of ROCs of the three formulations for the two values of σ are shown in FIG. 5. It can be easily seen that the quarter-sphere formulation

[image]

consistently outperforms the other two formulations; especially at the low value of regularization parameter. The best overall results are achieved with the medium regularization with σ=12, which has most likely been selected in [EAP⁺02] after careful experimentation. The advantage of the quarter-sphere in this case is not so dramatic as with low regularization, but is nevertheless very significant for low false alarm rates.

3.2 Dependency on the Ratio of Anomalies

The assumption that intrusions constitute a small fraction of the data may not be satisfied in a realistic situation. Some attacks, most notably the denial-of-service attacks, manifest themselves precisely in a large number of connections. Therefore, the problem of a large ratio of anomalies needs to be addressed.

In the experiments in this section we investigate the performance of the sphere and the quarter-sphere one-class SVM as a function of the attack ratio. It is known from the literature [TD99, SPST⁺01] that the parameter ν of the one-class SVM can be interpreted as an upper bound on the ratio of the anomalies in the data. The effect of this parameter on the quarter-sphere formulation is different: it specifies that exactly ν fraction of points is expected to be the anomalies. This is agreeably a more stringent assumption, and methods for the automatic determination of the anomaly ratio must be further investigated. Herein we perform a simple comparison of the algorithms under the following three scenarios:
the parameter ν matches exactly the anomaly ratio,
the parameter ν is fixed whereas the anomaly ratio varies,
the ratio of anomalies is fixed and the parameter ν varies.

Under the scenario that ν matches the anomaly ratio it is assumed that perfect information about the anomaly ratio is available. One would expect that the parameter ν can tune both kinds of one-class SVM to the specific anomaly ratio. This, however, does not happen, as can be seen from FIG. 6. One can observe that the performance of both formulations noticeably degrades with the increasing anomaly ratio. We believe that the reason for this lies in the data-dependent normalization of the features: since the features are normalized with respect to the mean, having a larger anomaly ratio shifts the mean towards the anomalies, which leads to worse separability of the normal data and the anomalies.

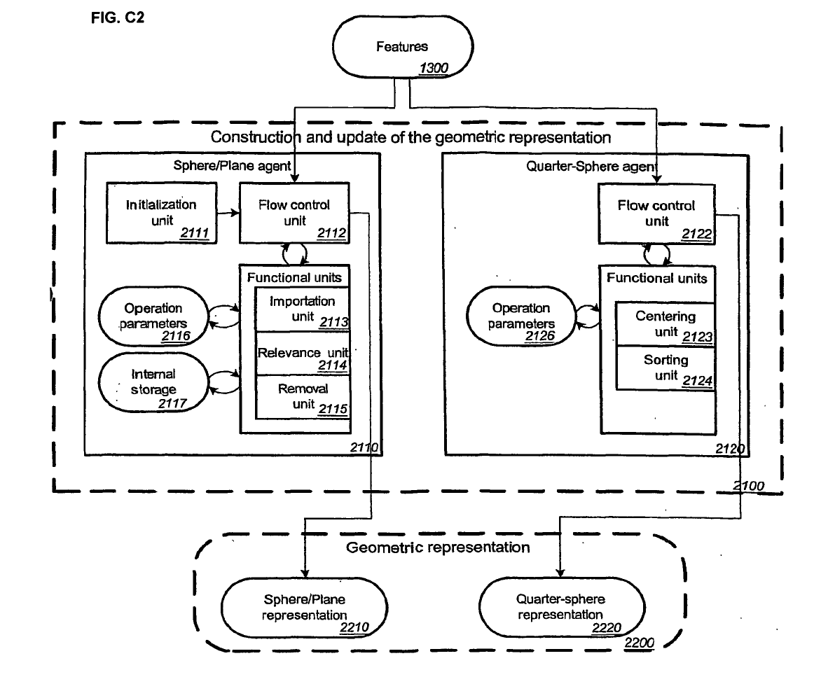

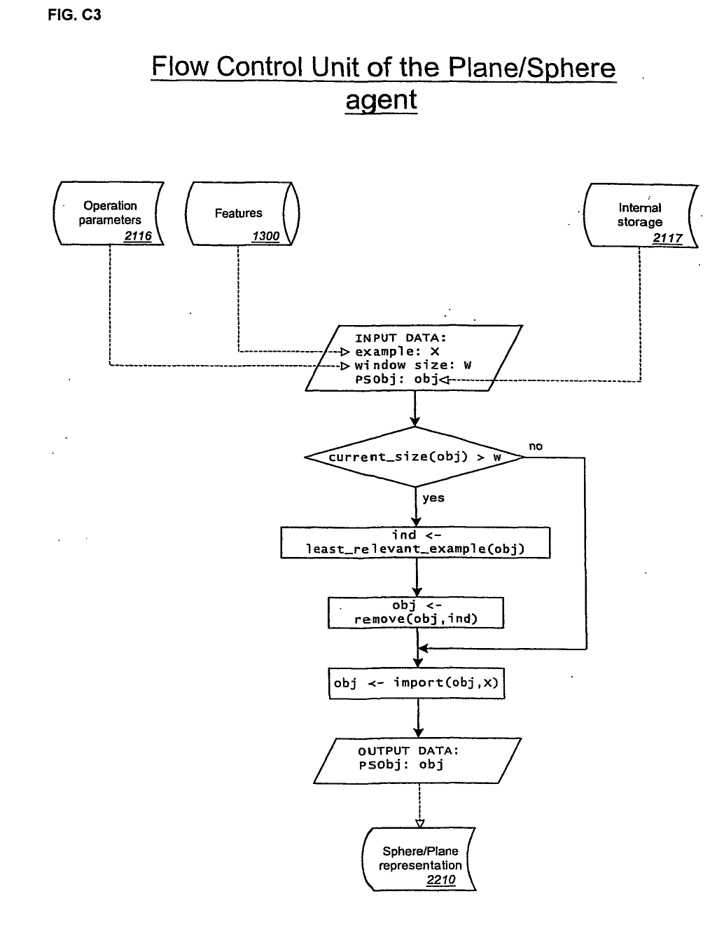

Under the scenario with fixed ν it is assumed that no information about the anomaly ratio is available, and that this parameter is simply set by the user to some arbitrary value. As one can see from FIG. 7, the performance of both formulations of one-class SVM degrades with increasing anomaly ratio similarly to the scenario with ν matching the true anomaly ratio. Notice that the spread in the accuracy, as the anomaly ratio increases, is similar for both scenarios. This implies that, at least for the data-dependent normalization as used in the current experiments, setting the parameter ν to a fixed value is a reasonable strategy.

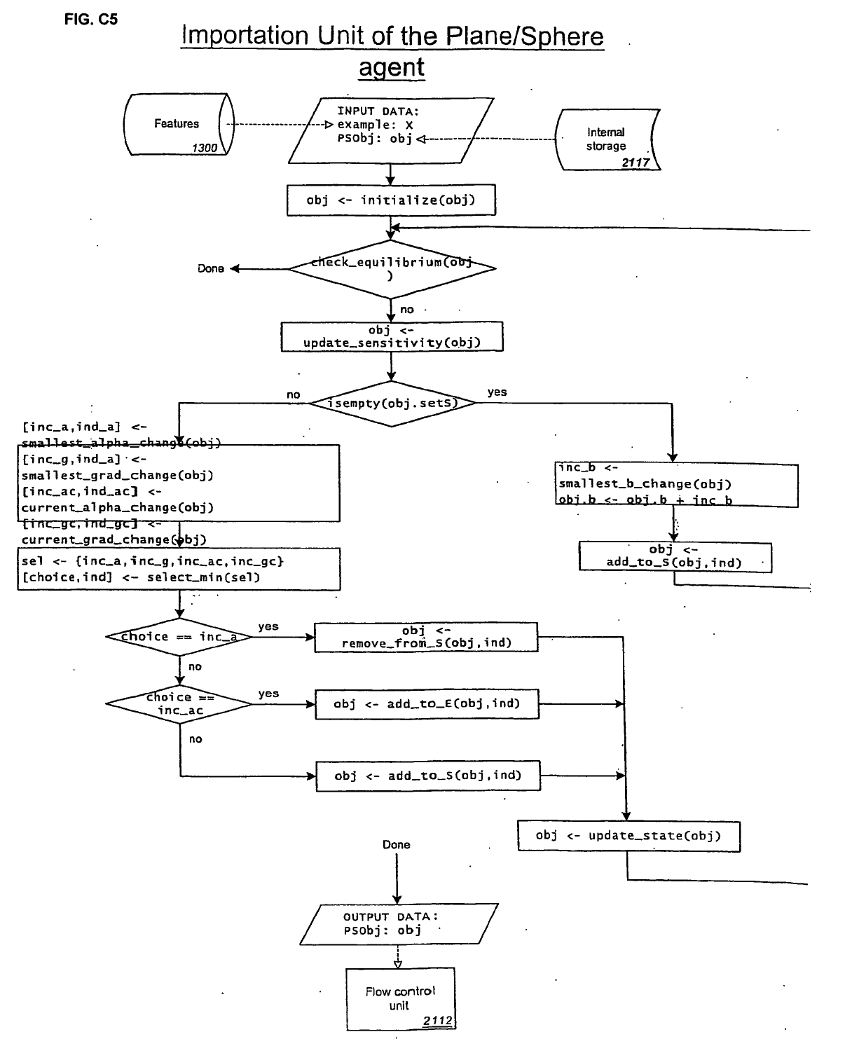

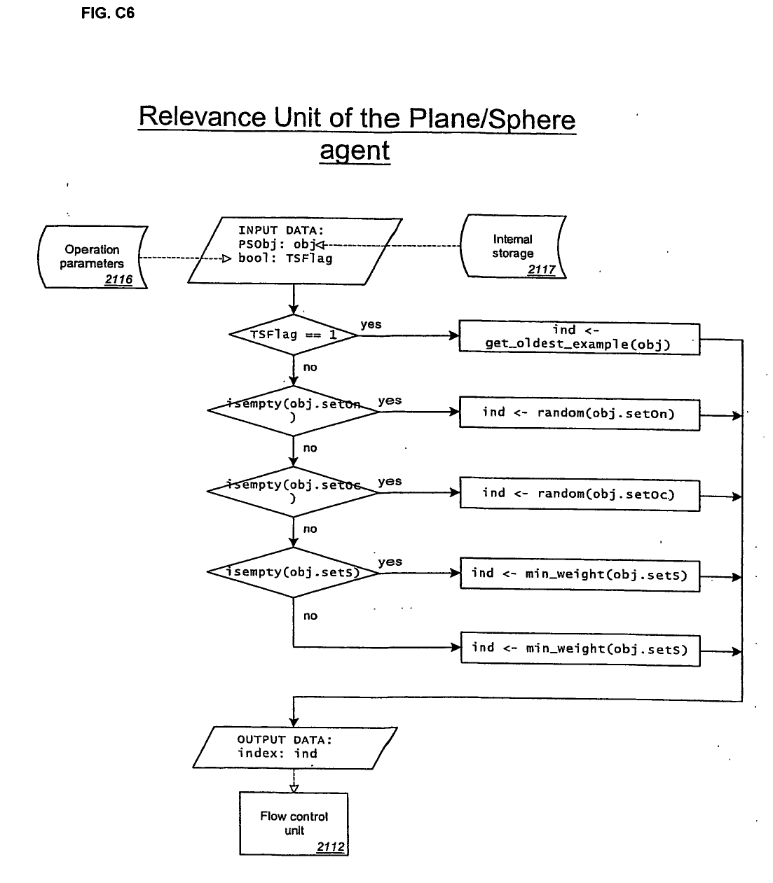

Under the scenario with fixed anomaly ratio and the varying ν we investigate what impact the adjustment of the parameter has on the same dataset. As it can be seen from FIG. 8, varying the parameter only has an impact on the sphere one-class SVM, the best accuracy

[image]

achieved on the higher values. The parameter ν does not have any impact on the accuracy of the quarter-sphere one-class SVM.

[image]

4 Conclusions and Future Work

We have presented a novel one-class SVM formulation, the quarter-sphere SVM, that is optimized for non-negative attributes with one-sided distribution. Such data is frequently used in intrusion detection systems. The one-class SVM formulations previously applied in the context of unsupervised anomaly detection do not account for non-negativity and one-sidedness; as a result, they can potentially detect very common patterns, their attributes close to the origin, as anomalies. The quarter-sphere SVM avoids this problem by aligning the center of the sphere fitted to the data with the “center of mass” of the data in feature space.

Our experiments conducted on the KDDCup 1999 dataset demonstrate significantly better accuracy of the quarter-sphere SVM in comparison with the previous, sphere or plane, formulations. Especially noteworthy is the advantage of the new algorithm at low false alarm rates.

We have also investigated the behavior of one-class SVM as a function of attack rate. It is shown that the accuracy of all three formulations of one-class SVM considered here degrades with the growing percentage of attacks, contrary to the expectation that the parameter ν of one-class SVM, if properly set, should tune it to the required anomaly rate. We have found that the performance degradation with the perfectly set tuning parameters is essentially the same as when the parameter is set to some arbitrary value. We believe that performance of anomaly detection algorithms on higher anomaly rates should be given special attention in the future work, especially with respect to the data normalization techniques.

Acknowledgements

The authors gratefully acknowledge the finding from the Bundesministerium für Bildung und Forschung under the project MIND (FKZ 01-C40A). We also thank Klaus-Robert Müller and Stefan Harmeling for valuable suggestions and discussions.

### REFERENCES

(BCJ⁺01] Barbará D., Couto, J., Jajodia, S., Popyack, L., und Wu, N.: ADAM: Detecting intrusions by data mining. In: Proc. IEEE Workshop on Information Assurance and Security. S. 11-16. 2001.
[De87] Denning, D.: An intrusion-detection model. IEEE Transactions on Software Engineering. 13:222-232. 1987.
[DR90] Dowell, C. und Ramstedt, P.: The ComputerWatch data reduction tool. In: Proc. 13th National Computer Security Conference. S. 99-108. 1990.
[EAP⁺02] Eskin, E., Arnold, A., Prerau, M., Portnoy, L., und Stolfo, S.: Applications of Data Mining in Computer Security. chapter A geometric framework for unsupervised anomaly detection: detecting intrusions in unlabeled data. Kluwer. 2002.
[JLA⁺93] Jagannathan, R., Lunt, T. F., Anderson, D., Dodd, C., Gilham, F., Jalali, C., Javitz, H. S., Neumann, P. G., Tamaru, A., und Valdes, A.: Next-generation intrusion detection expert system (NIDES). Technical report. Computer Science Laboratory, SRI International. 1993.
[LEK⁺03] Lazarevic, A., Ertoz, L., Kumar, V., Ozgur, A., und Srivastava, J.: A comparative study of anomaly detection schemes in network intrusion detection, In: Proc. SIAM Conf. Data Mining. 2003.
[LV92] Liepins, G. und Vaccaro, H.: Intrusion detection: its role and validation. Computers and Security. 11(4):347-355. 1992.
[NWY02] Noel, S., Wijesekera, D., und Youman, C.: Applications of Data Mining in Computer Security. chapter Modern intrusion detection, data mining, and degrees of attack guilt. Kluwer. 2002.
[PES01] Portnoy, L., Eskin, E., und Stolfo, S.: Intrusion detection with unlabeled data using clustering. In: Proc. ACM CSS Workshop on Data Mining Applied to Security. 2001.
[PN97] Porras, P. A. und Neumann, P. G.: Emerald: event monitoring enabling responses to anomalous live disturbances. In: Proc. National Information Systems Security Conference. S. 353-365. 1997.
[SMB⁺99] Schölkopf, B., Mika, S., Burges, C., Knirsch, P., Müller, K.-R., Rätsch, G., und Smola, A.: Input space vs. feature space in kernel-based methods. IEEE Transactions on Neural Networks. 10(5): 1000-1017. September 1999.
[SPST⁺01] Schölkopf, B., Platt, J., Shawe-Taylor, J., Smola, A., und Williamson, R.: Estimating the support of a high-dimensional distribution. Neural Computation. 13(7):1443-1471. 2001.
[SS02] Schölkopf, B. und Smola, A.: Learning with Kernels. MIT Press. Cambridge, Mass. 2002.
[SSM98] Schölkopf, B., Smola, A., und Müller, K.-R.: Nonlinear component analysis as a kernel eigenvalue problem. Neural Computation. 10:1299-1319. 1998.
[TD99] Tax, D. und Duin, R.: Data domain description by support vectors. In: Verleysen, M. (Hrsg.), Proc. ESANN. S. 251-256. Brussels. 1999. D. Facto Press.
[Va95] Vapnik, V.: The nature of statistical learning theory. Springer Verlag. New York. 1995.
[Va98] Vapnik, V.: Statistical Learning Theory. Wiley. New York. 1998.
[VS00] Valdes, A. und Skinner, K: Adaptive, model-based monitoring for cyber attack detection. In: Proc. RAID 2000. S. 80-92. 2000.
[WFP99] Warrender, C., Forrest, S., und Perlmutter, B.: Detecting intrusions using system calls:

alternative data methods. In: Proc. IEEE Symposium on Security and Privacy. S. 133-145. 1999.

FIG. 3—Operation of the Flow Control Unit of the Plane/Sphere Agent

The Flow control unit reads the following data as the arguments:
example ‘X’ from the stream of features (1300)
window size ‘W’ from the operation parameters (2116), set by the user
Plain/Sphere object (PSObj) ‘obj’ from the internal storage. This object is created by the initialization unit (2111) of the Plane/Sphere agent and is maintained throughout the operation of the flow control unit.

The following sequence of actions is performed in a loop for each incoming example ‘X’.
1. If the current size of the data stored in the object ‘obj’ is exceeds the window size ‘W’, some example needs to be removed before a new example can be imported.
2. To remove some example, in index ‘ind’ of the least relevant example is computed by issuing a request to the relevance unit (2114). After that the example with this index is removed by issuing a request to the removal unit (2115) with ‘ind’ as an argument. The updated state of the object is stored in ‘obj’.
3. Importation of the example ‘X’ is carried out by issuing a request to the importation unit (2113) with ‘X’ as an argument. The updated state of the object is stored in ‘obj’.

The resulting object ‘obj’ is the output data of the Flow control unit and it is passed to other parts of the online anomaly detection engine as the plane/sphere representation.
operation of the Initialization unit of the Plain/Sphere agent

At the beginning of the system's operation, the initialization unit overtakes the control from the flow control unit until the system can be brought into the equilibrium state. It reads the examples from the feature stream (1300), assigns them the weight of C and puts them into the set E until floor (1/C) examples has been seen. The next example get the weight of 1−floor(1/C) and is put into set S. Afterwards the control is passed back to the flow control unit.

FIG. 5—Operation of the Importation Unit of the Plain/Sphere Agent

The Importation unit reads the following data as the arguments:
example ‘X’ from the stream-of features (1300)
Plain/Sphere object (PSObj) ‘obj’ from the internal storage. This object is maintained throughout the operation of the flow control unit.

Upon reading the new example the importation unit performs initialization of some internal data structures (expansion of internal data and kernel storage, allocation of memory for gradient and sensitivity parameters etc.)

A check of equilibrium of the system including the new example is performed (i.e. it is verified if the current assignment of weights satisfies the Karush-Kuhn-Tucker conditions). If the system has reached the equilibrium state, the importation unit terminates and outputs the current state of the object ‘obj’. If the system is not in equilibrium processing continues until such state is reached.

Sensitivity parameters are updated so as to account for the latest update of the object's state or to compute the values corresponding to the initial state of the object with the new example added. Sensitivity parameters reflect the sensitivity of the weights and the gradients of all examples in the working set with respect to an infinitesimal change of weight of the incoming example.

Depending on whether or not the set S (maintained in the internal storage) is empty or not one of the following processing paths is taken.

If the set S is empty, the only free parameter of the object is the threshold ‘b’. To update ‘b’ the possible increments of the threshold ‘b’ are computed for all points in sets E and O such that gradients of these point are forced to zero. Gradient sensitivity-parameters are used to carry out this operation efficiently. The smallest of such increments is chosen, and the example, whos gradient is brought to zero by this increment is added to set S (and removed from the corresponding index set, E or O).

If the set S is not empty, four possible increments need to be computed so that the selection is made among them. The increment ‘inc_a’ is the smallest increment of the weight of the current example such that the induced change of the weights of the examples in set S brings the weight of some of these examples the border of the box (i.e. forces it to take on the value of zero or C). This increment is determined as the minimum of all such possible increments for each example in set S individually, computed using the weight sensitivity parameters. The increment ‘ind_g’ is the smallest increment of the weight of the current example such that the induced change of the gradients of the examples in sets E and O brings these gradients to zero. This increment is determined as the minimum of all such possible increments for each example in sets E and O individually, computed using the gradient sensitivity parameters. The increment ‘inc_ac’ is the possible increment of the weight of the new example. It is computed as the difference between the upper bound C on the weight of an example and the current weight a_c of the new example. The increment ‘inc_ag’ is the possible increment of the weight of the new example such that the gradient of the new example becomes zero. This increment is computed using the gradient sensitivity of the new example.

After the four possible increments are computed the smallest one among them and the index ‘ind’ of the example associated with the smallest respective increment is computed. Depending on which of the four increments yields the minimum value, the following processing steps are taken:

If the minimum is yielded by the increment ‘inc_a’ the example refered to by the index ‘ind’ is removed from set S.

If the minimum is yielded by the increment ‘inc_ac’ the example refered to by the index ‘ind’ (in this case it is the new example) is added to set E.

In the other two remaining cases (‘inc_g’ and ‘inc_gc’) the example refered to by the index ‘ind’ is added to set S.

After the composition of index sets is update, the state of the object is updated. This operation consists of applying the computed increments to the weights of all examples in the working set and to the threshold ‘b’.

The resulting object ‘obj’ is the output data of the Importation unit and it is passed to the flow control unit (2112).

FIG. 6—Operation of the Relevance Unit of the Plain/Sphere Agent

The Relevance unit reads the following data as the arguments:
Plain/Sphere object (PSObj) ‘obj’ from the internal storage (2117). This object is maintained throughout the operation of the flow control unit.
the flag ‘TCFlag’ from the operation parameters (2116). This flag indicates if the data has temporal structure.

If ‘TSFlag’ is set the oldest example in the working set is least relevant example.

Otherwise the following selection is made:

If set On (not cached examples from set O) of the object is not empty, an example is selected at random from the set On, otherwise

If set Oc (cached examples-from set O) of the object is not empty, an example is selected at random from the set Oc, otherwise

If set S is not empty, the example with the minimum weight is selected from set S, otherwise

The example is selected at random from the set E.

The output of the relevance unit is the index ‘ind’ of the selected example. It is passed to the flow control unit (2112).

FIG. 7—Operation of the Removal Unit of the Plain/Sphere Agent

The Removal unit reads the following data as the arguments:
index ‘ind’ from the flow control unit (2112)
Plain/Sphere object (PSObj) ‘obj’ from the internal storage (2117). This object is maintained throughout the operation of the flow control unit.

Upon reading the input arguments the removal unit performs initialization of some internal data structures (contraction of internal data and kernel storage, of gradient and sensitivity parameters etc.)

A check of the weight of the example ‘ind’ is performed. If the weight of this example is equal to zero, control is returned to the flow control unit (2112), otherwise operation is continues until weight of the example ‘ind’ reaches zero.

Sensitivity parameters are updated so as to account for the latest update of the object's state or to compute the values corresponding to the initial state of the object with the example ‘ind’ removed. Sensitivity parameters reflect the sensitivity of the weights and the gradients of all examples in the working set with respect to an infinitesimal change of weight of the outgoing example.

Depending on whether or not the set S (maintained in the internal storage) is empty or not one of the following processing paths is taken.

If the set S is empty, the only free parameter of the object is the threshold ‘b’. To update ‘b’ the possible increments of the threshold ‘b’ are computed for all points in sets E and O such that gradients of these point are forced to zero. Gradient sensitivity parameters are used to carry out this operation efficiently. The smallest of such increments is chosen, and the example, whos gradient is brought to zero by this increment is added to set S (and removed from the corresponding index set, E or O).

If the set S is not empty, three possible increments need to be computed so that the selection is made among them. The increment ‘inc_a’ is the smallest increment of the weight of the example ‘ind’ such that the induced change of the weights of the examples in set S brings the weight of some of these examples the border of the box (i.e. forces it to take on the value of zero or C). This increment is determined as the minimum of all such possible increments for each example in set S individually, computed using the weight sensitivity parameters. The increment ‘ind_g’ is the smallest increment of the weight of the current example such that the induced change of the gradients of the examples in sets E and O brings these gradients to zero. This increment is determined as the minimum of all such possible increments for each example in sets E and O individually, computed using the gradient sensitivity parameters. The increment ‘inc_ac’ is the possible increment of the weight of the example ‘ind’. It is computed as the negative difference between current weight a_c of the example ‘ind’ and zero.

After the three possible increments are computed the one with the smallest absolute value among them and the index ‘ind’ of the example associated with the smallest respective increment is computed. Depending on which of the three increments yields the minimum value, the following processing steps are taken:

If the minimum is yielded by the increment ‘inc_a’ the example refered to by the index ‘ind’ is removed from set S.

If the minimum is yielded by the increment ‘inc_ac’ nothing is to be done (this is the termination condition which is detected in the next iteration)

In the other remaining case (‘inc_g’) the example refered to by the index ‘ind’ is added to set S.

After the composition of index sets is updated, the state of the object is updated. This operation consists of applying the computed increments to the weights of all examples in the working set and to the threshold ‘b’.

After the termination of the loop the example being removed is purges, i.e. all data structures associated with it (kernel cache, index sets etc.) are permanently cleared out.

The resulting object ‘obj’ is the output data of the Removal unit and it is passed to the flow control unit (2112).

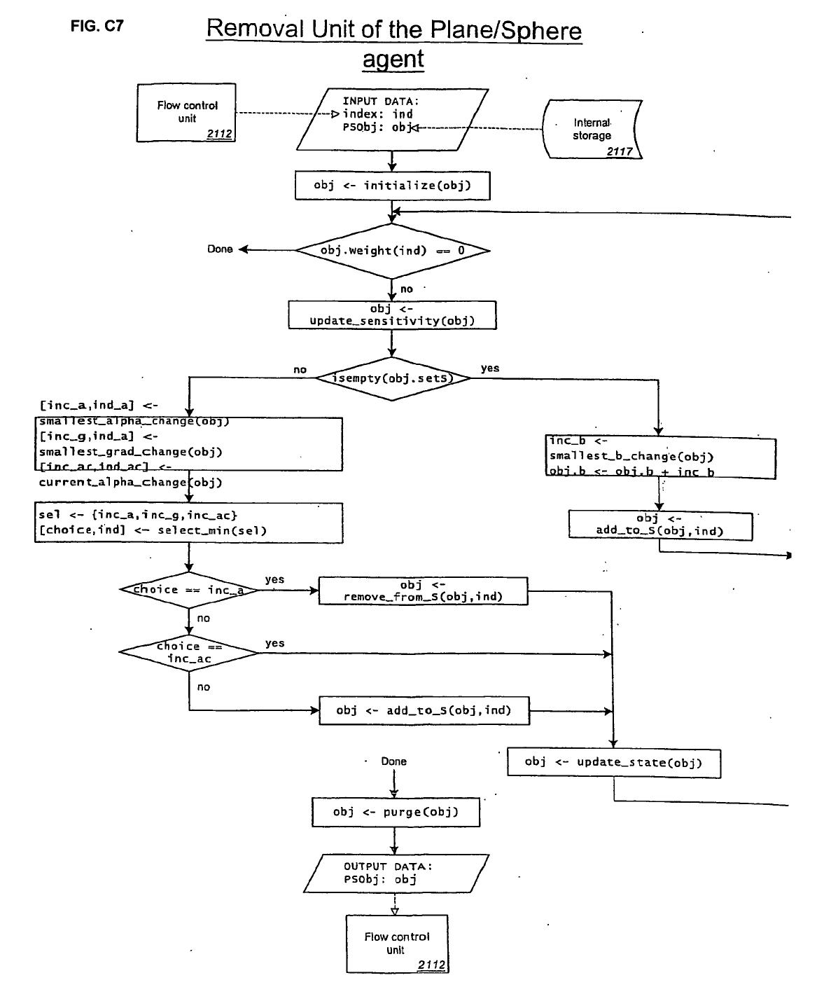

FIG. 10—Operation of the Flow Control Unit of the Quarter-Sphere Agent

The Flow control unit reads the following data as the arguments:
example ‘X’ from the stream of features (1300)
window size ‘W’ from the operation parameters (2116), set by the user
Quarter-Sphere object (QSObj) ‘obj’ from the internal storage. This object is maintained throughout the operation of the flow control unit.

The following sequence of actions is performed in a loop for each incoming example ‘X’.
1. If the current size of the data stored in the object ‘obj’ is exceeds the window size ‘W’, some example needs to be removed before a new example can be imported.
2. To remove some example, in index ‘ind’ of the example with the smallest norm is computed. After that the example with this index is removed by issuing a request “contract” to the centering unit (2123) with ‘ind’ as an argument. The updated state of the object is stored in ‘obj’.
3. Importation of the example ‘X’ is carried out by issuing a request “expand” to the centering unit (2123) with ‘X’ as an argument. The updated state of the object is stored in ‘obj’.
4. The state of the object is further updated by issuing a request to the sorting unit (2124) which maintains the required ordering of the norms of all examples.

The resulting object ‘obj’ is the output data of the Flow control unit and it is passed to other parts of the online anomaly detection engine as the plane/sphere representation.

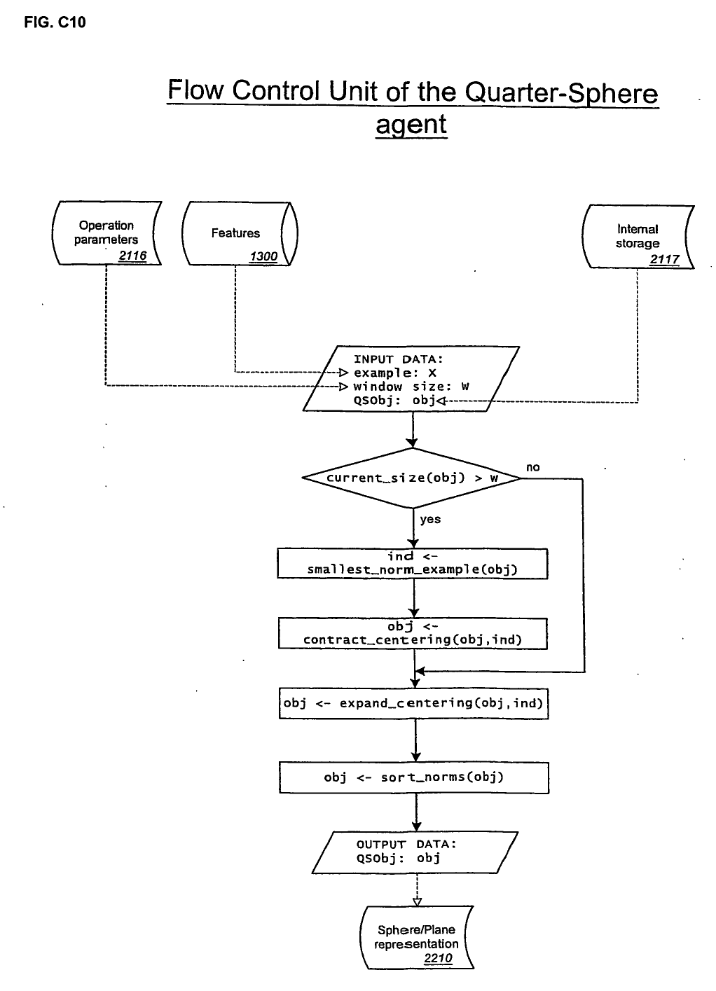

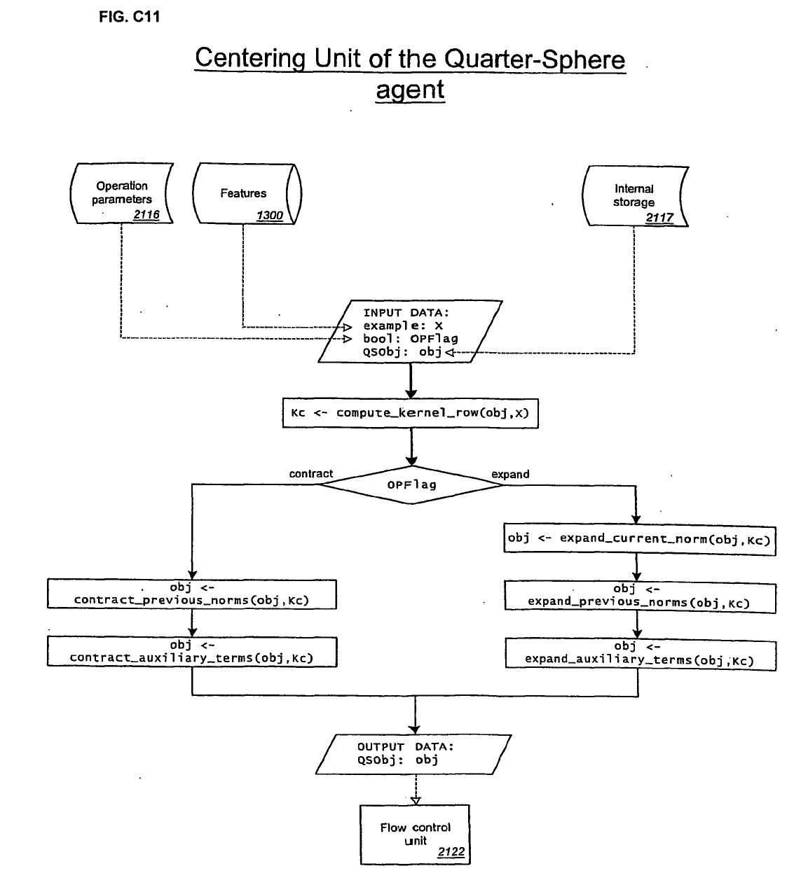

FIG. 11—Operation of the Centering Unit of the Quarter-Sphere Agent

The Centering unit reads the following data as the arguments:
example ‘X’ from the stream of features (1300)
Quarter-Sphere object (QSObj) ‘obj’ from the internal storage. This object is maintained throughout the operation of the flow control unit (2122).
the boolean flag ‘OPFlag’ which indicates the requested operation, “expand” or “contract”.

Upon reading of the example ‘X’ the centering unit computes the kernel row for this example, i.e. a row vector of kernel values for this example and all other examples in the working set.

Depending on the value of ‘OPFlag’ the following operations are performed:

If “expand” operation is requested,
expansion of the norm of example ‘X’ (“current norm”) is performed (see the formulas in the attached technical report)
expansion of the norms of other examples in the working set is performed
auxiliary terms are updated.

If “contract” operation is requested,
contraction of the norms of other examples in the working set is performed (see the formulas in the attached technical report)
auxiliary terms are updated.

The resulting object ‘obj’ is the output data of the Centering unit and it is passed to the flow control unit (2212).

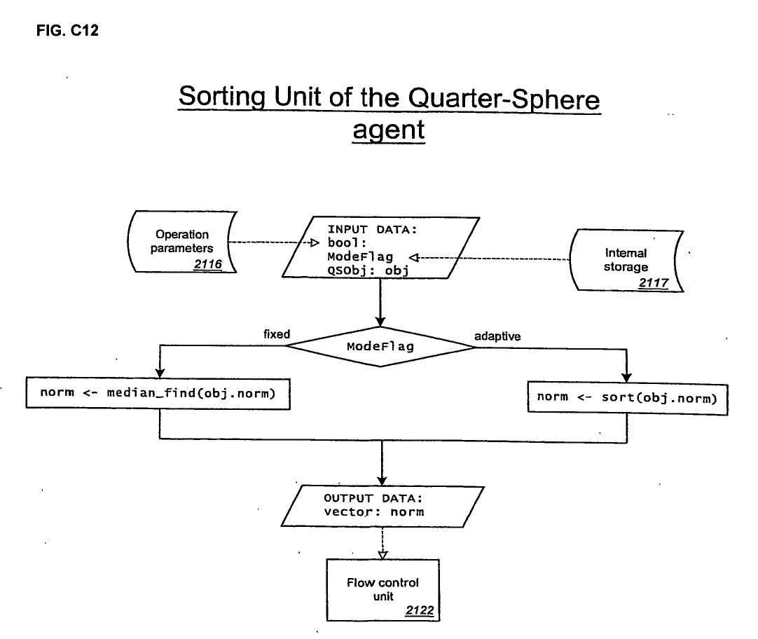

FIG. 12—Operation of the Sorting Unit of the Quarter-Sphere Agent

The Sorting unit reads the following data as the arguments:
Quarter-Sphere object (QSObj) ‘obj’ from the internal storage. This object is maintained throughout the operation of the flow control unit (2122).
the boolean flag ‘ModeFlag’ which indicates the mode of anomaly detection: “fixed” for the detection with fixed anomaly ratio, and “adaptive” for the mode in which the anomaly ratio is determined adaptively from the data.

Depending of the value of ‘ModeFlag’, the sorting unit invokes the usual sorting operation (e.g. QuickSort), of the adaptive mode is indicated, or the median finding operation (which is cheaper than sorting) if the fixed mode is indicated.

The output of the Sorting unit is the ordered vector of norms of the examples in the working set, where the ordering depends on the requested mode. This vector is passed to the flow control unit (2122).

This technical report provides some additional mathematical and technical details on implementation of quarter-sphere SVM.

1 The Quarter-Sphere Formulation

The dual formulation of the quarter-sphere SVM is given by the following linear program:

$${min}_{α ∈ {ℝ}^{1}} - {\sum }_{i = 1}^{l} {α}_{i} k ( {x}_{i} , {x}_{i} ) , \\ subject to \text{:} {\sum }_{i = 1}^{l} {α}_{i} = 1 , \\ 0 \leq {α}_{i} \leq \frac{1}{vl} . \qquad ( 1 )$$

The simplicity of equality constraints in problem (1) gives rise to an extremely efficient procedure of finding a solution. One can clearly see that in order to minimize the objective function of the problem (1) one should give as much weight as possible to the points with the largest norms k(xᵢ, xᵢ). Since the weight αᵢ is bounded above by 1/νl, the solution is to fix the weights at the upper bound for └ν┘ points with largest norms, and to assign the weight of

$$1 - \frac{⌊ {v}_{l} ⌋}{{v}_{l}}$$

to the next largest point. The remaining points become zero weights. From the algorithmic point of view, the problem amounts to finding an └νl┘-th order statistic, i.e. this can be solved in linear time by a “median-find” type of algorithm.

It may seem somewhat strange that the non-linear mapping affects the solution only through the norms k(xᵢ, xᵢ) of the examples; that is, the geometric relations between the objects are ignored. This feature indeed poses a problem for the application of the quarter-sphere SVM with the distance-based kernels. In such case, the norms of the points are equal, and no meaningful solution to the dual problem can be found. To avoid this predicament, centering of the images of the training points Φ(xᵢ) in feature space, which is a well-known technique originating from kernel PCA [2], can be applied. In other words, the values of image points are re-computed in the local coordinate system anchored at the center of mass of the image points. This is done by subtracting the mean from all image values:

$$\overline{Φ} ( {x}_{i} ) = Φ ( {x}_{i} ) - \frac{1}{l} {\sum }_{i = 1}^{l} Φ ( {x}_{i} ) .$$

Although this operation may be intractable in a high-dimensional feature space, the impact of centering on the kernel values can be easily computed (e.g. [2, 1]):
K̅=K−1ₗK−K1ₗ+1ₗK1ₗ, (2)
where K is the l×l kernel matrix with the values Kᵢⱼ=k(xᵢ, xⱼ), and 1ₗ is an l×l matrix with all values equal to 1/l. After centering in feature space, the norms of points in the local coordinate system are no longer all equal, and the dual problem of the quarter-sphere formulation can be easily solved.

From the computational point of view, the centering operation (2) poses a problem, since it has to be performed every time a new point is added to or removed from a dataset and the cost of this operation, if performed directly, is O(l³). Lucidly only l diagonal elements of \tilde{K} are used. In the following the formulas will be developed for computing the updates to the values of these elements when an example is added or removed.

1.1 Addition of an Example

In this section, the recursive relations connecting the values on the main diagonal of the centered kernel matrix K̅ before and after the addition of the l-th example are developed. First consider the centered value \tilde{K}ᵤ^{(l)}.¹ Observe that:

$$\begin{matrix}{\overline{K}}_{ll}^{( l )} = {( Φ ( {x}_{l} ) - \frac{1}{l} [ {\sum }_{i = 1}^{l - 1} Φ ( {x}_{i} ) + Φ ( {x}_{l} ) ] )}^{T} ( Φ ( {x}_{l} ) - \frac{1}{l} [ {\sum }_{i = 1}^{l - 1} Φ ( {x}_{i} ) + Φ ( {x}_{l} ) ] ) \\ = {( \frac{l - 1}{l} )}^{2} {Φ ( {x}_{l} )}^{T} Φ ( {x}_{l} ) - \frac{2 ( l - 1 )}{{l}^{2}} {Φ ( {x}_{l} )}^{T} {\sum }_{i = 1}^{l - 1} Φ ( {x}_{i} ) + \\ \frac{1}{{l}^{2}} {\sum }_{i = 1}^{l - 1} {\sum }_{j = 1}^{l - 1} {Φ ( {x}_{i} )}^{T} Φ ( {x}_{j} ) \\ = {( \frac{l - 1}{l} )}^{2} {K}_{ll} - \frac{2 ( l - 1 )}{{l}^{2}} {\sum }_{i = 1}^{l - 1} {K}_{li} + {( \frac{l - 1}{l} )}^{2} {F}^{( l - 1 )} ,\end{matrix}$$

where the auxiliary term F^{(l-1)} depending only on previous l−1 examples is defined as:

$${F}^{( l - 1 )} {=}^{Δ} \frac{1}{{( l - 1 )}^{2}} {\sum }_{i = 1}^{l - 1} {\sum }_{j = 1}^{l - 1} {K}_{ij} .$$

¹The superscript (1) denotes that the quantity pertains to the state after the example l is added.

In a similar we the value \tilde{K}ₖₖ^{(l)}, k<1, is obtained:

$$\begin{matrix}{\overline{K}}_{kk}^{( l )} = {( Φ ( {x}_{j} ) - \frac{1}{l} [ {\sum }_{i = 1}^{l - 1} Φ ( {x}_{i} ) + Φ ( {x}_{l} ) ] )}^{T} ( Φ ( {x}_{j} ) - \frac{1}{l} [ {\sum }_{i = 1}^{l - 1} Φ ( {x}_{i} ) + Φ ( {x}_{l} ) ] ) \\ = {Φ ( {x}_{k} )}^{T} Φ ( {x}_{k} ) - \frac{2}{l} {Φ ( {x}_{k} )}^{T} {\sum }_{i = 1}^{l - 1} Φ ( {x}_{i} ) + \frac{1}{{l}^{2}} {\sum }_{i = 1}^{l - 1} {\sum }_{j = 1}^{l - 1} {Φ ( {x}_{i} )}^{T} Φ ( {x}_{j} ) - \\ \frac{2}{l} {Φ ( {x}_{k} )}^{T} Φ ( {x}_{l} ) + \frac{2}{{l}^{2}} {Φ ( {x}_{l} )}^{T} {\sum }_{i = 1}^{l - 1} Φ ( {x}_{i} ) + \frac{1}{{l}^{2}} {Φ ( {x}_{l} )}^{T} Φ ( {x}_{l} ) \\ = {K}_{kk} - \frac{2 ( l - 1 )}{l} {G}_{k}^{( l - 1 )} + {( \frac{l - 1}{l} )}^{2} {F}^{( l - 1 )} - \\ \frac{2}{l} {K}_{kl} + \frac{2}{{l}^{2}} {\sum }_{i = 1}^{l - 1} {K}_{li} + \frac{1}{{l}^{2}} {K}_{ll} ,\end{matrix}$$

where the auxiliary term Gₖ^{(l-1)} depending only on previous l−1 examples is defined as:

$${G}_{k}^{( l - 1 )} {=}^{Δ} \frac{1}{l - 1} {\sum }_{i = 1}^{l - 1} {K}_{ki} .$$

It can be easily seen, that, apart from the cost of computing the auxiliary terms F^{(l-1)} and Gₖ^{(l-1)}, computation of the update to each diagonal entry of Kₗₗ takes O(1) time (taking into account that

$${\sum }_{i = 1}^{l - 1} {K}_{li}$$

needs to be computed only once and can be amortized over all l diagonal entries). Finally, it remains to be shown that maintaining the auxiliary terms does not cost any extra work. The following recursive relationships hold between the respective auxiliary quantities:

$${F}^{( l )} = \frac{1}{{l}^{2}} {K}_{ll} + \frac{2}{{l}^{2}} {\sum }_{i = 1}^{l - 1} {K}_{li} + ( \frac{l - 1}{l} ) {F}^{( l - 1 )}$$

$${G}_{k}^{( l )} = \frac{( l - 1 )}{l} {G}_{k}^{( l - 1 )} + \frac{1}{l} {K}_{kl} .$$

The amortized cost of these operations is O(1).
1.2 Removal of an Example

A similar recursive technique underlies the update formulas for the removal of an example. To simplify the notation we assume that the example to be removed has index l. In this case only the diagonal values of K̅ for examples with k<l are to be updated:

$$\begin{matrix}{\overline{K}}_{kk}^{( l - 1 )} = {( Φ ( {x}_{j} ) - \frac{1}{l - 1} [ {\sum }_{i = 1}^{l} Φ ( {x}_{i} ) + Φ ( {x}_{l} ) ] )}^{T} \\ ( Φ ( {x}_{j} ) - \frac{1}{l - 1} [ {\sum }_{i = 1}^{l} Φ ( {x}_{i} ) - Φ ( {x}_{l} ) ] ) \\ = {Φ ( {x}_{k} )}^{T} Φ ( {x}_{k} ) - \frac{2}{l - 1} {Φ ( {x}_{k} )}^{T} {\sum }_{i = 1}^{l} Φ ( {x}_{i} ) + \\ \frac{1}{{( l - 1 )}^{2}} {\sum }_{i = 1}^{l} {\sum }_{j = 1}^{l} {Φ ( {x}_{i} )}^{T} Φ ( {x}_{j} ) - \frac{2}{l - 1} {Φ ( {x}_{k} )}^{T} Φ ( {x}_{l} ) + \\ \frac{2}{{( l - 1 )}^{2}} {Φ ( {x}_{l} )}^{T} {\sum }_{i = 1}^{l} Φ ( {x}_{i} ) + \frac{1}{{( l - 1 )}^{2}} {Φ ( {x}_{l} )}^{T} Φ ( {x}_{l} ) \\ = {K}_{kk} - \frac{2 l}{l - 1} {G}_{k}^{( l )} + {( \frac{l}{l - 1} )}^{2} {F}^{( l )} + \\ \frac{2}{l - 1} {K}_{kl} - \frac{2}{{( l - 1 )}^{2}} {\sum }_{i = 1}^{l} {K}_{li} + \frac{1}{{( l - 1 )}^{2}} {K}_{ll} .\end{matrix}$$

The recursive relations between the auxiliary terms are computed as follows:

$${F}^{( l - 1 )} = \frac{1}{{( l - 1 )}^{2}} {K}_{ll} - \frac{2}{{( l - 1 )}^{2}} {\sum }_{i = 1}^{l} {K}_{li} + ( \frac{l}{l - 1} ) {F}^{( l )}$$

$${G}_{k}^{( l - 1 )} = \frac{( l )}{l - 1} {G}_{k}^{( l )} - \frac{1}{l - 1} {K}_{kl} .$$

The analysis of the update expressions above reveals that all operations have running time of O(1) except

$${\sum }_{i = 1}^{l} {K}_{li}$$

which can be carried out once and amortized over all l−1 entries to be updated.

### REFERENCES

[1] B. Schölkopf, S. Mika, C. J. C. Burges, P. Knirsch, K.-R. Müller, G. Rätsch, and A. J. Smola. Input space vs. feature space in kernel-based methods. IEEE Transactions on Neural Networks, 10(5):1000-1017, September 1999.
[2] B. Schölkopf, A. J. Smola, and K.-R. Müller. Nonlinear component analysis as a kernel eigenvalue problem. Neural Computation, 10:1299-1319, 1998.

1-8. (canceled)

9. A supporting frame structure for a motor vehicle, comprising:
member-type elements and
junction elements connecting the member-type elements,
wherein
at least one of the junction elements is a cast-steel element, and
at least one of the member-type elements is a rolled steel profile.

10. The supporting frame structure as claimed in claim 9, wherein at least one of the member-type elements and the junction elements is formed from high-quality steel.

11. The supporting frame structure as claimed in claim 9, wherein at least one of the member-type elements and the junction elements are formed from high-strength steel.

12. The supporting frame structure as claimed in claim 9, wherein at least one of the member-type elements and the junction elements have wall thicknesses matched to the load.

13. The supporting frame structure as claimed in claim 9, wherein a connection of the member-type elements to the junction elements is a mechanical joining connection.

14. The supporting frame structure as claimed in claim 9, wherein a connection of the member-type elements to the junction elements is a fusion welding connection.

15. The supporting frame structure as claimed in claim 9, wherein a connection of the member-type elements to the junction elements is an adhesive connection.

16. The supporting frame structure as claimed in claim 9, wherein a connection of the member-type elements to the junction elements is a brazed connection.
